(19) United States
(12) Patent Application Publication
(10) Pub. No.: US 2006/0162593 A1
(43) Pub. Date: Jul. 27, 2006

(54) Printing machine, modus operandi of said printing machine and printed products

(76) Inventor: Claus August Bolza-Schunemann, Wurzburg (DE)

Correspondence Address: Douglas R Hanscom;Jones Tullar & Cooper, P O Box 2266, Eads Station, Arlington, VA, 22202, US

(21) Appl. No.: 10/542,901

(22) PCT Filed: Jan. 16, 2004
(86) PCT No.: PCT/EP04/50022

§ 371 Date: Jul. 21, 2005

(30) Foreign Application Priority Data
Jan. 30, 2003 (DE) 10303841.8
Feb. 17, 2003 (DE) 10306505.9
Mar. 15, 2003 (DE) 10321989.7

(51) Int. Cl. B41F 5/18

(52) U.S. Cl. 101/180

(57) ABSTRACT

A printing machine has at least one printing tower that is formed having two stacked satellite printing units. At least one further printing unit is situated on a plane that is above the printing location of the upper satellite printing unit of the at least one printing tower. The printing machine is operable in a mode of operation to produce a printed product.

### CROSS-REFERENCE TO RELATED APPLICATIONS

This patent application is the U.S. national phase, under 35 U.S.C. 371, of PCT/EP2004/050022, filed Jan. 16, 2004; published as WO 2004/067275 A1 on Aug. 12, 2004, and claiming priority to DE 103 03 841.8 filed Jan. 30, 2003; to DE 103 06 505.9, filed Feb. 17, 2003; and to DE 103 21 989.7, filed May 15, 2003, the disclosures of which are expressly incorporated herein by reference.

### FIELD OF THE INVENTION

The present invention is directed to a printing press, to an operating method of the printing press and to printed products. The printing press has at least one print tower that includes two stacked satellite print units and at least one additional printing press above the print level of the upper satellite unit.

### BACKGROUND OF THE INVENTION

In “Der Rollenoffsetdruck” by W. Walenski, Fachschriftenverlag GmbH & Co. KG, 1995, varied configurations are disclosed, on pages 96 and 97 thereof, for offset towers and web paths in offset printing, e.g. two stacked nine-cylinder satellite offset towers.

“Offsetdrucktechnik” by H. Teschner, Fachschriftenverlag GmbH & Co. KG, 1995, discloses, on page 10/32 in FIG. 6, a nine-cylinder satellite offset tower, on which is arranged a three-cylinder Colordeck unit for accomplishing 4/1 printing.

DE 25 28 008 A1 shows a printing press for a direct printing method using forme cylinders that can be assembled axially with six printing plates, and around the circumference with two printing plates and using impression cylinders that can be covered axially with three blankets and around the circumference with one. The printing plates, which are arranged close to each other and the blankets which are arranged close to each other, are, in each case, arranged offset with respect to each other around the circumference of the respective cylinders.

DE 25 10 057 A1 discloses a printing press with a direct printing method. The forme cylinder, which is interacting with an impression cylinder, carries over its width six printing plates and carries, around its circumference, two printing plates.

Through JP 56-021860 there is known an offset tower with forme, transfer and impression cylinders. Each of the three cylinders is driven by its own drive motor.

Through DE 41 28 797 A1 there is known a triple width web-fed rotary press with two formers. These are arranged on two different levels, one above the other.

From “Newspapers & Technology”, December 2000, there is known a printing press with offset towers having the width of six newspaper pages. The offset towers are formed as bridge offset towers, the transfer cylinders of these offset towers being clad with blankets.

WO 01/70608 A1 discloses a turner bar arrangement. Two essentially partial web-width turner bars are each movably arranged on a mount transversely to the incoming partial web. In each case, at the side, and at the outside, the side frame is arranged a table roll, the longitudinal axis of which runs essentially parallel to the side frame and which also can be moved along a rail in a direction crosswise to the incoming partial web.

From U.S. Pat. No. 4,671,501 A there is known a fold assembly two formers are arranged, one above the other, whereby the webs, after passing through rise rollers, are cut longitudinally before a third former. The partial webs are turned through 90° via a third former and are then gathered together in two ribbons and are fed to the two formers arranged one above the other.

Through EP 1 072 551 A2 there is known a fold assembly with two groups of formers which are vertically offset against each other. Above each group of formers is a harp, such as a group of collecting, take-off or even harp rollers, and via which the partial webs are fed to the assigned group of formers.

In WO 97/17200 A2 there is known a fold assembly, in which trimmed partial webs offset crosswise to each other are fed to different formers. The formers are arranged horizontally close to each other and are, in part, vertically offset with respect to each other.

DE 44 19 217 A1 shows a superstructure of a web-fed rotary printing press with a turn unit. Partial webs are offset by half a partial web width in order to run them one above the other and to feed them to a common former.

EP 0 638 419 A1 discloses printing towers adjoining each other, each comprising two stacked satellite printing units.

Printing towers consisting of a three-or a six-cylinder printing unit stacked on a satellite printing unit are disclosed in Finkbeiner, G. “Investment Decisions in Connection with Newspaper Publishing Should Always be Based on the Planned Workload” in Deutscher Drucker, No. 36/ Sep. 30, 1993, pages W35 to W37, XP 000398176.

DE 24 22 696 C2 shows a six plate wide satellite printing unit with offset printing groups having nine or ten cylinders. The two center printing formes of six plates, which are arranged side-by-side in the axial direction, are arranged offset in the circumferential direction on the forme cylinder in relation to the ones on the outside.

### SUMMARY OF THE INVENTION

The present invention is directed to providing a printing press, an operating method for the printing press and a printed product.

The problem is solved according to the invention by the provision of a printing machine with at least two stacked satellite print units which are stacked above each other. The printing machine has at least one additional printing press arranged in a plane above the print position of the upper satellite unit. Printed webs from the satellite units can then be printed by the at least one further printing press.

The benefits achievable with the present invention consist, in particular, in that a simple, inexpensive and space-saving configuration is enabled with, at the same time, great variability in the product and/or intermediate product.

There are also, in particular, advantages in that reliability of production is considerably increased compared with a double-width printing press with the same desired thickness to be achieved of a product. By retaining the number of offset towers, however, the output of the printing press and of each offset tower can be increased by 50%.

The number of roll changers, and their required cost investment, the frequency of reel change, which effects the reliability of production, and the set-up time when webbing up, or the cycle times, can be reduced compared with a double-width printing press for the same product thickness.

In an advantageous performance of the present invention, the offset towers are executed as nine-cylinder satellite offset towers, which results firstly in great precision in the ink register and secondly in a low-vibration configuration. Vibrations are also reduced by the advantageous arrangement, execution and attachment of coverings on the cylinders. For one thing, circumferential openings in the jacket surface are minimized. Furthermore, at least on the transfer cylinder, these openings can be arranged offset alternately around the circumference so that, at least for one section length, a closed jacket surface is always interacting with the forme or satellite cylinder. Thirdly, circularity errors and production costs are minimized in that although axial through-channels are provided for the barrel over its whole effective length, there are openings through to the jacket surface only in the appropriate sections. Then devices for, for example, fastening covering ends and/or linings are optionally inserted.

In each case, at least six devices for use in the axial positioning of printing formes are arranged in the channels of the forme cylinders. These are, for example, executed as register pins acting together positively with printing form ends, with the pins being able to be moved within the channel either manually or by remote control.

An advantage, with respect to the fitting of forme cylinders with printing formes that can be reproduced precisely in register, is the version of offset towers with assigned pressing devices. With these devices, blankets on the jacket surface of the cylinder can be fixed, as needed, by at least one pressing element, while an end of a blanket or of several blankets is released for removal or for fitting.

The drive, independent mechanically of the cylinder pairs, of the satellite cylinder or cylinders involves, in particular, advantages with respect of the possibility of variable operation. Thus, for example, a set-up, such as an on-the-fly change of a printing forme or a wash-up, can take place during production. Conversely, a web can be drawn in, while other cylinders or while cylinder pairs are stopped or a set-up program is running. It is also an advantage, when there are blankets with positive or negative conveying properties, to operate the satellite cylinder at a surface speed different from the other cylinders.

In an advantageous version of the invention, a superstructure of the printing press has at least one slitting device with at least five knives spaced crosswise to the paper flow direction. In an advantageous version, there are for each print tower, or for every eight printing points, two register devices movable transversely to the paper flow direction to compensate for runs of the partial webs. These can, in a further development, each be structurally combined with a partial web-wide turning device. Also, subsequent guide elements can be assigned merely to partial webs and are essentially configured merely to the width of the partial web. These versions allow a low-vibration, and hence again a precise transport of the web. Fluctuations in web tension caused by inertia of long, thick guide elements and driven only on the partial web or webs, in the case of, for example changes of load, or change of printing speed can be effectively reduced.

With regard to reliable operation and to cost-saving design, it is also an advantage to provide in the superstructure the possibility of turning a partial web through an uneven multiple of a half partial web. This dispenses with the need for drawing in and for printing partial webs, such as a newspaper page, with a half former width.

With respect to costs and to space-saving design it is an advantage of the present invention, in one version, to assign a so-called harp, with several normally undriven rise rollers, only to one of two superimposed formers. Webs can be transferred from the harp to the other former. Ribbons of variable thickness or of number of partial webs can be fed to the formers arranged vertically above each other from the same line of partial webs lying above each other.

In one version, partial webs can be admitted from a harp assigned to one group of formers to another former group and vice versa. In an advantageous version, one so-called harp, with several undriven rise rollers, also called collecting or take-off rollers in line, is to be assigned to only one of two superimposed formers. Webs can then be transferred from the common harp to the other former. Ribbons of variable thickness or of variable numbers of partial webs can be fed to the formers which are arranged vertically above each other from the same line of partial webs lying above each other.

In an advantageous version of a turn unit in accordance with the present invention, the partial web can be or is moved merely through an uneven multiple of a half partial web width. It can thus be avoided, with very little expense, having to print very narrow webs or to provide additional offset towers. The version, which is movable crosswise to the web, of at least one of the turner bars makes for great variability.

The drive of rollers of the former superstructure and/or of the folder, independent mechanically of the offset towers, is advantageous, in particular, with regard to good registration and variable operation.

With the six cylinder tower and with the web paths, there are advantages, in particular, in that a great variety of products can be achieved and a flexible and exact drive is possible in conjunction with the various drive situations.

### BRIEF DESCRIPTION OF DRAWINGS

Preferred examples of the present invention are shown in the drawings and are described in more detail in the following.

The following Figures show:

FIG. 1 a side view of a web-fed rotary printing press;

FIG. 2 a diagrammatic end view of an offset tower;

FIG. 3 a diagrammatic top view of an offset tower;

FIG. 4 an exploded view of a covering;

FIG. 5 a forme cylinder in; a: exploded view, b: in longitudinal section, c: with a support element, d: with a support element with register device;

FIG. 6 a transfer cylinder; in a: exploded view, b: in longitudinal section, c: with a support element, d: with a filling piece;

FIG. 7 a device for pressing a covering onto a cylinder;

FIG. 8 a first preferred embodiment for the drive of a nine-cylinder satellite offset tower;

FIG. 9 a second preferred embodiment for the drive of a nine-cylinder satellite offset tower;

FIG. 10 a third preferred embodiment for the drive of a nine-cylinder satellite offset tower;

FIG. 11 a form of execution of the preferred embodiment depicted in FIG. 8;

FIG. 12 a general schematic arrangement of a superstructure, in a perspective view;

FIG. 13 a first preferred embodiment of a register device in accordance with the present invention;

FIG. 14 a second preferred embodiment of a register device;

FIG. 15 a depiction for a web turn;

FIG. 16 a front view of a harp with turned web as shown in FIG. 15;

FIG. 17 a folder assembly of a web-fed rotary printing press;

FIG. 18 a side elevation view of the folder assembly of FIG. 17, with web path;

FIG. 19 a front view of the folder assembly with web path;

FIG. 20 a schematic side elevation view of the folder;

FIG. 21 a first web path/a first preferred embodiment;

FIG. 22 a second web path/a second preferred embodiment;

FIG. 23 a third web path/a third preferred embodiment;

FIG. 24 a fourth web path/a fourth preferred embodiment;

FIG. 25 a fifth web path/a fifth preferred embodiment; and

FIG. 26 a diagrammatic side view of a second execution of the folder.

### DESCRIPTION OF PREFERRED EMBODIMENTS

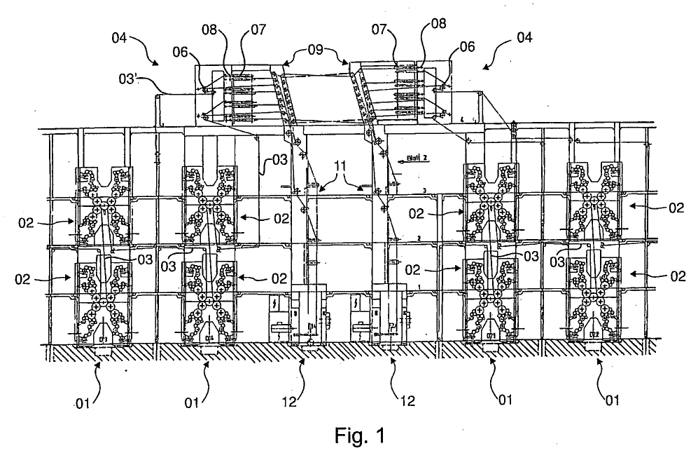

A web-fed rotary printing press, as shown by way of example in FIG. 1, has a left-hand section and a right-hand section each with at least two printing towers 01. The printing towers 01 each have printing units 02, which, for example, are made at least with a threefold width, i.e. for printing at a time six newspaper pages which are arranged axially alongside each other. The printing units 02 are configured as satellite printing units 02. The advantageous execution of the printing units 02 as nine-cylinder satellite printing units 02 guarantees very good registration and low fan-out. The printing units 02, however, can also be made as ten-cylinder satellite printing units 02 or possibly also as printing units that can be operated in blanket-to-blanket printing, like, for example, several bridge printing units or an H-printing unit 02. Webs 03 are fed to the printing units 02 from reels that are not shown, in particular using splicers.

Downstream from a web 03 passing through the printing towers 01 or printing units 02, are depicted in FIG. 1 as being situated above the printing towers 01, a superstructure 04 is provided for each section, in which the web 03 or webs 03 can be cut at slitters, partial webs can be possibly transferred and/or converged by turning devices 07, can be aligned with each other and can be run one above the other by use means of register units 08 in the longitudinal register 08, which is indicated schematically in FIG. 1. Downstream, in the direction of web travel, the superstructure 04 has at least one so-called harp 09 with a number of harp or rise rollers arranged one above the other and carrying the webs 03 or partial webs 03a, 03b, 03c. The harp 09 determines the former infeed of the webs being run one above the other. Via this harp 09, the webs 03 undergo a change of direction and are then gathered together either as a single ribbon or as several ribbons and are fed to at least one folder assembly 11.

In the embodiment depicted in FIG. 1, two folder assemblies 11 are arranged between the printing press sections, which folder assemblies 11 have formers arranged, in each case, on two different levels one above the other. The printing press, however, can also have merely one joint folder assembly 11 arranged between the sections, or can merely have one section and an assigned folder assembly 11. Also, the respective folder assembly 11 can be executed with only one level of formers. One or more folders 12 are assigned to each folder assembly 11.

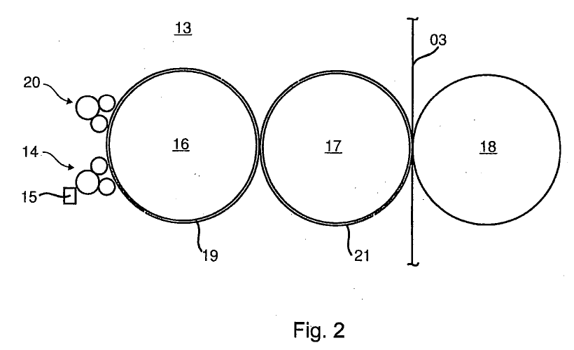

The printing unit 02 has several, and in the depicted configuration has four, printing groups 13, as seem in FIG. 2 and by use of which ink can be applied to the web 03 from an inking system 14 via at least one cylinder 16 executed as forme cylinder 16. In this execution of the printing unit 02 as a satellite printing unit 02, the printing group 13 is executed as an offset tower 13 for wet offset and has, in addition to the inking system 14, a dampening system 20 and another cylinder 17 executed as transfer cylinder 17. The transfer cylinder 17 forms, in cooperation with a further printing cylinder 18 forming an abutment, a printing point. In the example in FIG. 1 and FIG. 2, the printing cylinder 18 is executed as a satellite cylinder 18, which, in cooperation with further transfer cylinders 17 of further printing groups 13, forms further printing points in a Print On position. The printing cylinder 18 could also be executed as a second transfer cylinder 18 when making the printing groups a double printing group in blanket-to-blanket printing. The same parts are given the same reference numbers unless otherwise necessary for distinguishing. There may be a difference in position, which is normally disregarded when assigning these same reference numbers.

The inking system 14 has, in an advantageous execution, an ink fountain 15 extending over a length of six printed pages. In another version of the invention, three ink fountains are arranged axially alongside each other, each being about two printed pages wide. The dampening system 20 is, in an advantageous version, executed as a four-roller spray moistening system 20.

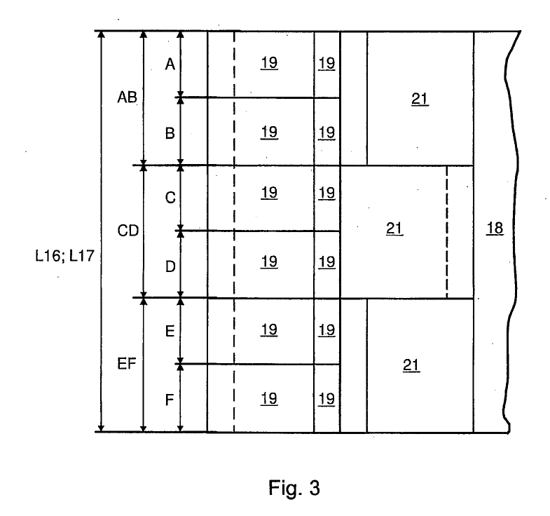

The forme cylinder 16 has, in a first execution, a circumference of between 850 and 1000 mm, and in particular from 900 to 940 mm. The circumference is configured and sized to take two portrait printed pages, such as newspaper pages in broadsheet format, using two coverings 19, such as flexible printing formes 19, that can be fixed, one after the other, circumferentially on the forme cylinder 16. The printing formes 19 can be mounted circumferentially on the forme cylinder 16 and in the execution of the invention shown in FIG. 3, each printing forme 19 can be individually replaced with a single printing plate with a printed page axially.

The length L16 of the usable barrel of the forme cylinder 16 is, in the first version 1850 to 2400 mm, and, in particular, is between 1900 to 2300 mm, and is dimensioned to take at least six portrait printed pages arranged alongside each other, in particular newspaper pages in broadsheet format. In this regard, see FIG. 3, sections A to F. It depends, among other things, on the nature of the product to be produced whether only one printed page or several printed pages are arranged axially alongside each other on a printing forme 19. In an advantageous wider variant, the length L16 of the usable barrel is between 2000 and 2400 mm.

In a second version of the invention, the forme cylinder 16 has a circumference between 980 and 1300 mm, and in particular from 1000 to 1200 mm. The length L16 of the usable barrel is from 1950 to 2400 mm, and in particular is from 2000 to 2400 mm. The configuration is the same as in the above-mentioned version.

The transfer cylinder 17 has, in the first version, a circumference between 850 and 1000 mm, and in particular from 900 to 940 mm. The length L17 of the usable barrel of the transfer cylinder 17 is in the first version 1850 to 2400 mm, and in particular is 1900 to 2300 mm, and has positioned longitudinally alongside each other three dressings or coverings 21, such as blankets 21, indicated at sections AB to EF. These dressings 21 extend circumferentially essentially around the whole circumference of the transfer or blanket cylinder 17. The blankets 21, for the purpose of favorably influencing the vibration behaviour of the printing group 13 in operation, are arranged alternating offset to each other, for example, by 180°, as seen in FIG. 3. In the wider variant of the first version, the length L17 of the usable barrel is similarly between 2000 and 2400 mm.

In a second version of the printing group 13, the transfer cylinder 17 has a circumference of between 980 and 1300 mm, and in particular from 1000 to 1200 mm. The length L17 of the usable barrel is here 1950 to 2400 mm, and in particular 2000 to 2400 mm. The arrangement of coverings 21 is the same as in the first version.

Diameters of barrels of cylinders 16, 17 in the first above-mentioned version are, for example from 270 to 320 mm, and in particular are from about 285 to 300 mm. In the second above-mentioned version, the diameter of barrels of cylinders 16, 17 is from about 310 to 410 mm, and in particular is from 320 to about 380 mm. A ratio of the usable length of the barrel of cylinders 16, 17 to their diameter should be from 5.8 to 8.8, preferably from 6.3 to 8.0, and in the wide version in particular from 6.5 to 8.0.

Length L16, L17 of the usable barrel is to be understood as the axial width or length of the barrel, which is suitable for receiving dressings or coverings 19, 21. This is the same roughly also of a maximum possible web width of a web 03 to be printed. In addition to such an overall length of the barrel of cylinders 16, 17, there should be added to this length L16, L17 of the usable barrel also the width of any bearers, of any keyways and/or of any jacket surface areas, which, for example, have to be accessible for the operation of suitable tensioning or clamping devices.

In an advantageous version of the present invention, the satellite cylinder 18 similarly has essentially the same dimensions and ratios of at least the assigned transfer cylinder 17.

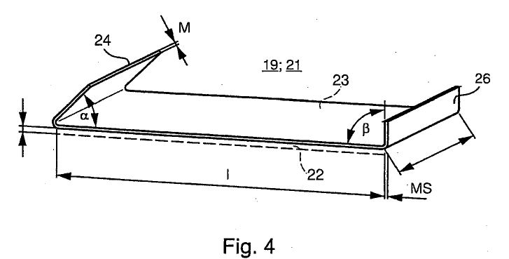

Dressings or 19, 21 are shown diagrammatically in FIG. 4 and are typically executed as flexible plates, whereby the dressing which is executed as blanket 21 is executed as a so-called metal blanket with an elastic and/or compressible layer 22, depicted by a line of dashes, arranged on a bearer plate. In FIG. 4 the references concerning only the metal blanket 21 are shown with dashed lines. A plate-shaped printing forme 19 or a bearer plate 23 for a blanket consists normally of a flexible, but otherwise dimensionally stable material, such as, for example, an aluminium alloy, and has two opposite ends 24, 26 to be fastened in or on the cylinder 16, 17 and with a material thickness MS of, for example from 0.2 mm to 0.4 mm, and preferably of 0.3 mm, these ends being folded to be formed as angled ends 24, 26 each located adjacent a bending line in relation to the extended length l of the covering 19, 21 by an angle α, β between 40° and 140°, preferably 45°, 90° or 135°, as seen in FIG. 4. A leading angled plate securement end 24, is for example, folded at an acute angle α of 40° to 50°, and in particular of 45°, and a trailing end 26 is folded at an angle β of 80° to 100°, and in particular 90°. If only a single cover 21 is applied to the circumference of the cylinder 16, 17, in particular to the circumference of the transfer cylinder 17, the length l of the cover 21 is almost the same as the circumference of this cylinder 17.

Basically, the folded or angled securement ends 24, 26 of the covers 19, 21 can each now be inserted into a slotted opening extending parallel to the longitudinal axis of the cylinder 16, 17, the ends being held by their shaping, friction or deformation. However, they can also be fixed by spring force, by pressure or by a centrifugal force of something that can be actuated and which is effective during operation. The slotted openings for printing plates 19 on the forme cylinder 16 arranged axially alongside each other are, in an advantageous version, each arranged in a row, such as in a continuous slotted opening, as described below, while the openings for the dressings or blankets 21 arranged alongside each other on the transfer cylinder are not continuous, but are offset with respect to each other alternating by 180° circumferentially.

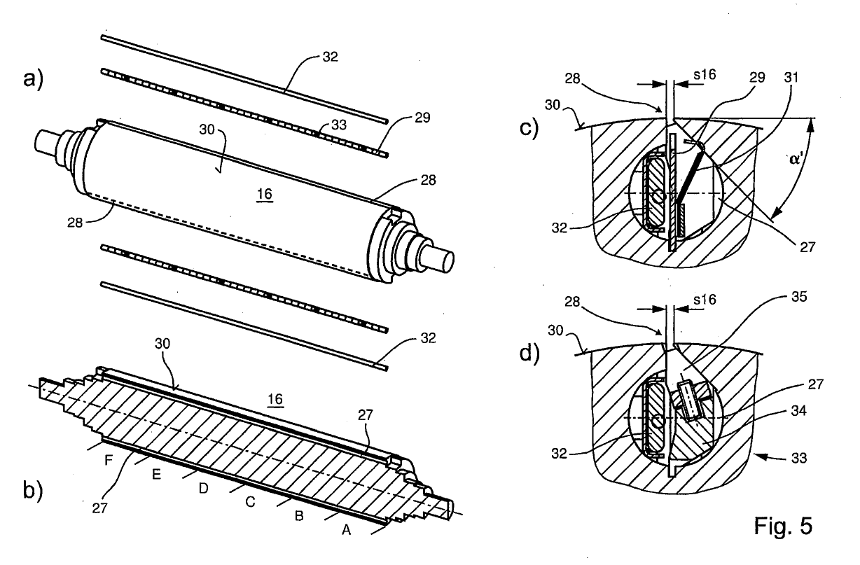

FIGS. 5a and 5b show, in exploded view, an example of an advantageous embodiment of the forme cylinder 16. In forme cylinder 16 there are provided two channels 27, the two channels 27 each extending axially through the length of cylinder 16 at least through the entire length of the six sections A to F in the barrel, as seen in FIG. 5b. They are arranged offset with respect to each other, by, for example, 180°, around the circumference of the cylinder 16. The channels 27 are executed beneath a jacket surface 30 inside the cylinder 16, as, for example circular holes, and each have a narrow slotted opening 28 to the jacket surface 30 of the cylinder 16 at least over the length of the six sections A to F as seen in FIG. 5a. A slot width s16 of opening 28 or the forme cylinder 16 is less than 5 mm circumferentially and is preferably in the range 1 mm to 4 mm. as seen in FIG. 5c.

The folded ends 24, 26 of printing forme 19 can now each be inserted in one of the openings 28 parallel to the axis longitudinally around the circumference and can be fixed, at least the trailing end 26, by a retainer device 29, 31 which is arranged in the channel 27.

The retainer device 29, 31 has, as seen in FIG. 5c, at least one clamping piece 29 and a spring element 31. The trailing end 26, which is folded at a right angle, not shown here, but seen in FIG. 4, comes to rest preferably on a side of the opening 28 of essentially complementary shape and is pressed down there by a clamping piece 29 by a spring element 31 acting on the clamping piece 29. The leading end 24 of the clamping plate, which is folded at an acute angle, and shown in FIG. 4 comes to rest preferably against a side of opening 28 of essentially complementary shape for the fold, which, with jacket surface 30, forms an insertion edge or nose at an acute angle α′ of 40° to 50°, in particular 45°. There is an actuator 32 in the channel 27 for loosening the clamping of the trailing end 26, which, on activation, counters the force exerted by the spring element 31 on the clamping piece 29 and swivels the clamping piece 29 away from the side or the end 26.

In an advantageous embodiment, there is not only one clamping piece 29 in each channel 27, but several clamping pieces 29, provided in the nature of segments, each with at least one spring element 31, which are arranged axially alongside each other over the length of sections A to F, which, in FIG. 5a are shown “drawn out” of the cylinder 16. In the practical example for each section A through F there are several, such as six, such clamping pieces 29 arranged, as shown in FIG. 5c, whereby a register block 35 with a register element 33, shown in FIG. 5d, is located centrally between the clamping elements 29 of each of the sections A through F, in this case between the third and fourth clamping element 29 of each of the section A thro F. The register block 35 or register pin 35 is manually moveable and is adjustable within an arrangement such as a groove in a base 34. In a further development, which is not shown, the register block 35 can also be moved axially in a space of channel 27, which remains free, or in the activation direction of the register element 33, for instance with a motorised threaded spindle.

The actuating mechanism 32 is implemented in the arrangement shown, such that when actuating the clamping element, or elements 29, 31, all the clamping elements 29 over the length of sections A through F are simultaneously closed or released. The actuating mechanism 32 is shown “extracted” from cylinder 16 as shown in FIG. 5a for at least the length of sections A through F axially along channel 27 and with the provision of a reversibly deformable hollow body 32, such as hose 32 for use in conjunction with a pressure device. This hose 32 is arranged as shown in FIG. 5c together with clamping pieces 29 of that type, which operate together in channel 27, so that, when actuated, hose 32 acts against the fail-safe force of spring elements 31 which hold the retaining elements in the closed position. It runs through the region of the register elements 33, as seen in FIG. 5d.

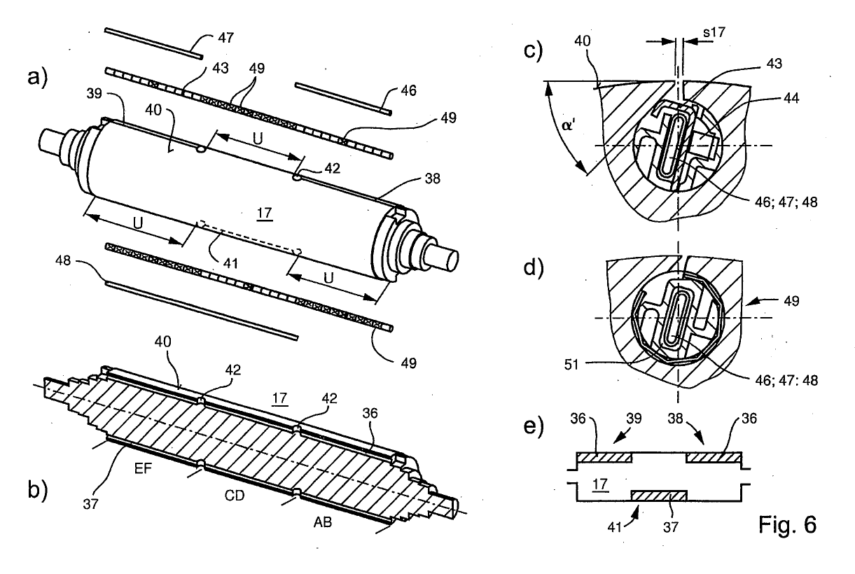

FIGS. 6a and 6b show an isometric view of an example of an advantageous arrangement of the transfer or blanket cylinder 17. Two channels 36 and 37 are provided within the cylinder 17, and both channels 36 and 37 run through the axial length of cylinder 17, at least over the entire length of the six sections A through F, the three sections AB; CD; EF in the assembly, as seen in FIG. 6b. They are spaced around the circumference of cylinder 17 for example by 180° from each other.

Channels 36 and 37 are typically two circular drilled holes, both lying underneath the outer circumference 40 and within cylinder 17, there being in total typically three, such channels in each case running axially, for at least the length of section AB; CD; EF. Sufficiently narrow slotted openings 38; 39; 41 provide an opening to the outer circumference 40 of cylinder 17, as seen in FIG. 6a. Two of the three openings 38; 39 connect to the same channel 36 and are axially in line with each other, but axially apart from each other on the outer circumference 40. Axially between the two spaced openings 38; 39 there exists a continuous surface of the outer circumference 40, in particular the unmachined section U in which there is no opening. The two openings 38; 39 that are in line with each other, are both, for instance, in communication with the same channel 36 and are preferably the openings 38; 39 near to the end faces of the cylinder. The third opening 41 extends axially only to the extent of the center section CD and is displaced at 180° relative to the other openings 38; 39. The slot width s17 of the uncovered openings 38; 39; 41 on the transfer cylinder 17, in the direction of the outer circumference, is always less than 5 mm wide, and preferably should lie in the range of 1 mm to 3 mm, as seen in FIG. 6c. For manufacturing reasons, one or both of the ends of the slots 38; 39; 41 typically are arranged as radial run-outs to the drilled holes 42; which slots, under operating conditions for cylinder 17, can be or are sealed with a plug, which is not shown in FIG. 6b. The plug, when fitted, will exhibit an outer face that forms a continuation of the otherwise cylindrical outer contour of the cylinder 17 in the region of the drilled hole 42. In an advantageous arrangement, a vertical cut in the circumference of cylinder 17 is made perpendicular to the axis of rotation axis and is made at just one of the openings 38; 39; 41 or at one of the openings 38; 39; 41 that has been terminated with a plug. This cut should not be considered as overlapping the openings 38; 39; 41 or the openings 38; 39; 41 where they are terminated with a plug.

The bevelled ends 24; 26 of the rubber blanket 21 can now each be tucked into one of the openings 38; 39; 41 in the circumference parallel to the axis, and can each be secured, at least at the trailing end 26 at least by one of the clamping pieces 43; 44 arranged in each of channels 36; 37. It is advantageous that both ends 24; 26 of the same rubber blanket 21 are fed through the same opening 38; 39; 41 in the same channel 36; 37.

The retaining devices 43; 44 each here include at least one clamping piece 43; 44 and a spring element 44, shown in FIG. 6c. The square bevelled trailing locating arm 26, as shown in FIG. 4, is mounted advantageously on one of the bevels essentially forming a complementary side wall to openings 38; 39; 41 and is held in place there by clamping piece 43 due to the force exerted by spring element 44 on clamping piece 43. The acute-angled bevelled leading locating arm 24, shown in FIG. 4, is fitted advantageously on one of the bevels essentially forming a complementary side wall to openings 38; 39; 41, which, with the outer circumference 40, forms an attachment edge or nose with an acute angle α′ of 40° to 50°; and in particular of 45° to the assembly. To release the clamp of the trailing end 26, at least one actuating mechanism 46; 47; 48 is provided in channel 36; 37, which actuating mechanism, when activated, acts against the force exerted by spring element 44 on the clamping piece 43 in the opposite direction, and the clamping piece 43 is then swung away from the line of the wall. In an advantageous arrangement of this type, at least one actuating mechanism 46; 47; 48 is provided for each of the three openings 38; 39; 41 in each of the associated channels 36; 37. In FIG. 6a this is shown “extracted” from the cylinder 17.

In an advantageous arrangement, in each channel 36; 37 there is not only a single clamping piece 43 but instead there are several clamping pieces 43 situated axially alongside each other along the length of sections AB; CD; EF and which can be arranged as individual segments each with at least one spring element 44 which, in FIG. 6a are shown “extracted” from the cylinder 17. In the arrangement example, in each section AB; CD; EF and in each opening 38; 39; 41 there are several, for example ten, of this type of clamping piece 43 as shown in FIG. 6c. In sections AB; CD; EF of each channel 36; 37 which have no opening to the outer face of the outer circumference 40, instead of the retaining device 43, 44 or the retaining devices 43, 44 there is at least one filler element 49, shown in FIG. 6d, in channel 36; 37. In the depicted example, there are several, such as eleven, of there filler elements 49 as individual segments in the respective places on sections AB; CD; EF of channels 36; 37 with no opening to the outer face of the outer circumference 40. A filler element 49, as seen in FIG. 6d, can also be arranged centrally between the retaining devices 43, 44 of each section AB; CD; EF, for example in the area between sections A and B, and E and F, here between the fifth and sixth clamping element 43. The filler element 49 exhibits essentially a cross-section that mimics the cross-section of the channel 36; 37 and at least one through opening 51 in the axial sense, through which the activating medium for the actuating mechanism 46; 47; 48 can pass.

The actuating mechanism 46; 47; 48 in the arrangement shown in Figs. BC and BD is arranged so that the activation of the retaining device 43, 44 for a section AB; CD; EF causes all the clamping pieces 43 of a section AB; CD; EF to be closed or to be released simultaneously. The actuating mechanism 46; 47; 48 is, as shown in FIG. 6a, “extracted” from the cylinder 17. In channel 36 provided with two openings 38; 39, an actuating mechanism 46; 47 extends from each end face over at least the respective length of the section AB; EF. The actuating mechanism 48 for the center opening 41 extends also for at least the respective length of the section CD. It can extend however also on at least one side up to the end face of cylinder 17, if this is advantageous for feeding the activating media, as seen in FIG. 6a. The actuating mechanisms 46; 47; 48 run, in each case, axially in channel 36; 37 and can be activated with compressed media within reversibly deformable hollow bodies 46; 47; 48, such as a hose 46; 47; 48. This hose 46; 47; 48 is arranged, as shown in FIG. 6c, with the clamping piece 43 of that type operating together in channel 36; 37, which hose, when activated, acts against the force exerted by spring element 44 on the clamping piece 43 in the opposite direction. This is fed through the area of suitable filler elements 49 and through the opening 51, as seen in FIG. 6d.

In a different version, the channels 36; 37 also need not each extend over the entire length. So, for example in the region of the sections AB; CD; EF, each channel 36; 37 can, as required, be provided with a respective retaining device, so that channel 37 with the centre blanket 21 is displaced by 180° compared to the two outer ones. This is shown in an outline schematic fashion in FIG. 6e.

In an arrangement that is particularly advantageous for printing using an offset tower 02 and using cylinders 16; 17 of six page widths wide, at least two cylinders 16; 17, and in particular two forme cylinders 16, in at least one print tower 01 there is arranged a device 52 for pulling a proof from a blanket 19; 21 on a cylinder 16; 17, in particular a print former on the form cylinder 16 which will be referred to in the following as a proof-pulling device 52. This is advantageous, for instance, if, in two corresponding printing machines 13, a quick, or a flying plate change is to be performed. In particular, it is advantageous for a quick, reliable and precise change of product if one of these types of proof-pulling device 52 is provided for all the forme cylinders 16 of a print tower 01. A corresponding proof-pulling device 52 exhibits one or more proof-pulling elements 53; 54, such as bars, push rods or roller elements 53; 54, which can be optionally attached to one or more of the blankets 19; 21. This allows a controlled and smooth take-up tensioning and or release or removal of the blanket 19; 21. It also enables the insertion of an end 24; 26 of the blanket 19; 21 into the respective channel 27; 36; 37 and the opening 28; 38; 39; 41, or that the partially released blanket 19; 21 can be held down in the desired position. The proof-pulling device 52 extends lengthwise along the cylinder 16; 17 at least in the same region as sections A through F, for example in the range of the assembly effective for printing.

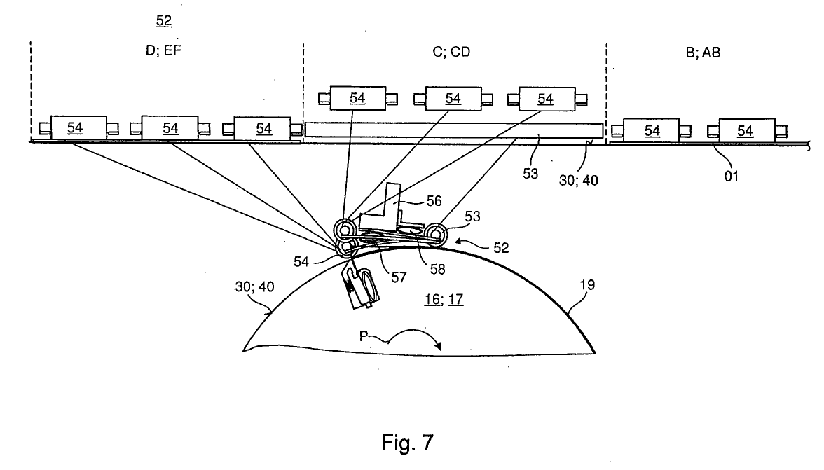

The configuration of the proof-pulling device 52, described in connection with FIG. 7, is particularly advantageous also in connection with the common actuating mechanism 32 arrangement extending over all section A thro F. In this configuration, a single or a group loading, changing and/or removal of printing formers 19 can be performed, even for six formers alongside each other on a forme cylinder 16, without requiring a lot of work for the actuator devices or for operating material feed within the form cylinder 16. Production, installation and maintenance are all significantly simplified by this.

The proof-pulling device 52 exhibits, for each section A through F, for up to six adjoining blankets 21 or for sections AB; CD; EF, for up to three adjoining blankets 21, at least a first proof-pulling element 53, such as a roller element 53. In an advantageous arrangement, as shown in FIG. 7, it exhibits, for each section A through F, or for sections AB; CD; EF, a second proof-pulling element 54, which is spaced circumferentially around the cylinder 16; 17 apart from this first roller element 53. In FIG. 7 for the case of the forme cylinder 16, only the center sections B, C, and D and the roller elements 53; 54 associated with these centre sections B, C, and D are shown. For each section A through F and for AB through EF, there are arranged a first roller element 53 or a group of roller elements 53 arranged alongside each other, in the axial sense, and also a second roller element 54 or a group of second roller elements 54 arranged alongside each other, in the axial sense. In the example for each section A through F and for AB through EF, there are shown a first roller element 53 and a group of three second roller elements 54. Advantageously, in view of the risk of possible tipping and thus of an incorrect axial alignment, the arrangement of groups should be such that there are at least two roller elements 53; 54 which can be moved independently of each other. A single roller element 53; 54 for a section A through F or for AB through EF is, for example, positioned in the longitudinal sense, extending almost to the length of the roller 53; 54 for the section A through F or AB through EF; a roller element 53; 54 of a group, in contrast, extends merely, at the most, of the fraction of the length of the roller 53; 54 for the section A through F or AB through EF.

The roller elements 53; 54 are arranged axially alongside each other, and the roller elements 53; 54, if provided, lie behind them, in a circumferential sense. These roller elements can always be moved independently of each other on, for instance, a traverse 56, or on several traverses 56. The single first roller element 53 or a group of first roller elements 53 of each one of section A through F or AB through EF, and also, where provided, the single second roller element 54 or a group of second roller elements 54 of each one of section A through F or AB through EF, can be activated independently of each other by use of their own actuating mechanism 57; 58. These actuating mechanisms 57; 58 function through the use of a reversibly deformable hollow body 57; 58 pressure device, such as a hose 32. However, other types of actuating mechanisms that are electrically or magnetically actuated can also be used.

For use in clamping a blanket 16; 17 into a section A through F or AB through EF, the leading acute angle bevelled end 24 of the blanket 16; 17 is fed into the opening 28; 38; 39; 41. The first roller element 53 for this section A through F or AB through EF, and, if provided, the second roller element 54 for this section A through F or AB through EF is placed on the cylinder 16; 17, or on the previously tensioned and located blanket 19; 21. If one or more further blankets 19; 21 are already mounted on the cylinder 16; 17, and it is desired to keep them there, than the first and/or second roller elements 53; 54 for these sections A through F or AB through EF should also be placed on the respective blankets 19; 21. If the first and second roller elements 53; 54 are provided, when the cylinder 16; 17 with roller elements 53; 54 starts to rotate, the second roller element 54 will push the trailing bevelled end 26 of the dressing or blanket into the opening 28; 38; 39; 41 as it rolls over it. If only the first roller elements 53 are fitted, then these perform the pressing down. It is advantageous that the roller elements 53; 54 remain fixed in place for this, while cylinder 16; 17 rotates in the production direction P. The retaining devices, previously placed in the release or open position for sections A through F or AB through EF, such as by operation of one or more clamping pieces 29; 43, change to their hold or closed retaining position. After the retaining devices have changed from the release position to their retaining position, all of the roller elements 53; 54 of the respective section A thro F or AB thro EF of cylinder 16; 17 and its blanket 19; 21 are switched off.

On relaxing a blanket 19; 21, it must then be taken into account whether one or more other blankets 19; 21 should remain on the cylinder 16; 17. In this first case, at least one of the roller elements 53; 54, which is associated with the blankets 19; 21 that are to remain, should be clamped or should remain clamped in the region of the trailing end 26 or near the opening 28; 38; 39; 41. The roller elements 53; 54, which are associated with the blankets 19; 21 that are to be released, should be unclamped or should remain unclamped. The retaining devices for sections A through F or AB through EF are opened. The trailing end 26 of the blanket 19; 21 to be removed is ejected, by its own spring force, from the channel 27; 36; 37, while the blankets 19; 21 to be retained are held down by roller elements 53; 54. The retaining device is then closed again. If the actuating mechanism is fitted with both first and second roller elements 53; 54, the blankets 19; 21 to be retained are advantageously held down by at least the second roller elements 54. For the blankets 19; 21 to be removed, if the actuating mechanism is fitted with both first and second roller elements 53; 54 then initially at least the second roller element 54 should be switched off, so that the end 26 can escape from the channel 27; 36; 37, and the first roller element 54 should be switched on, so that the already partially released blanket 19; 21 is still guided and is held by cylinder 16; 21.

The cylinder 16; 17 can then advantageously be rotated counter to the production rotation P, until the leading end 24 is ejected from the channel 27; 36; 37, and the blanket 19; 21 can then be removed. If, when the blanket 19; 21 is released, no remaining blankets 19; 21 require consideration, then the roller elements 53; 54 of the blankets 19; 21 for sections A through F or AB through EF, that are not to be released, can be taken, during the procedure and in principle at any operating position, preferably switched off.

At least one proof-pulling element 53; 54 can thus be secured, as required, to blankets 19; 21 that are positioned on the outer circumference 30; 40 of cylinder 16; 17, while an end 24; 26 of a blanket 19; 21 or of several blankets 19; 21 are released, i.e. at that point in time are not used for proof-pulling.

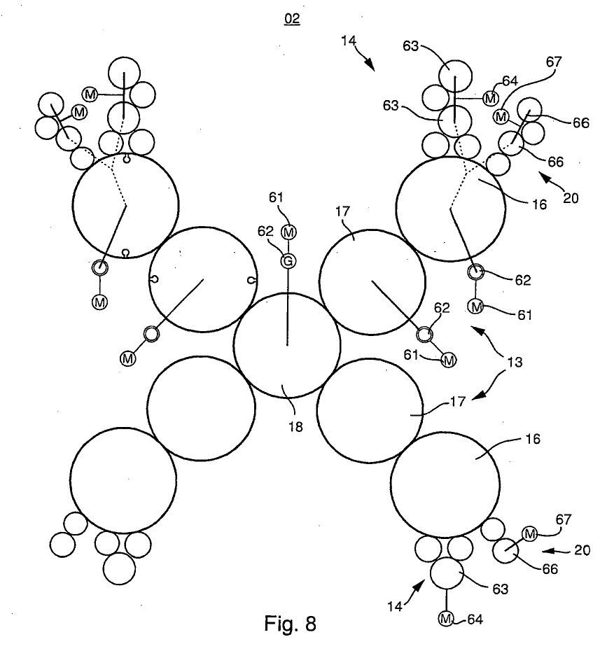

In an advantageous arrangement of the present invention, cylinders 16; 17 of the offset tower 02 can be driven so that the printing machines 13 of the offset tower 02 are each rotationally driven by at least one drive motor that is mechanically independent of the other printing machines 13. The drive motors 61, as depicted schematically in FIG. 8, are preferably electric motors 61 which are controlled by their angular position, such as, for example, asynchronous motors, synchronous motors or direct current motors. In an advantageous further development, there is at least one gearbox 62 between the drive motor 61 and the cylinder 16; 17; 18 or cylinder pair 16; 17; 18, 18 being driven, and in particular a reduction gearbox 62, such as, for example, a spur and pinion gearbox, an ancillary gearbox and/or a planetary gearbox. The use of individual drives contributes to high flexibility and to avoidance of vibration in the mechanical drive systems, and thus contributes to high quality in the resultant product. In the following FIGS. 8 through 10, only the components on the right hand side of the press are identified with their reference numbers, since the left hand side of the press is simply a mirror image of the right hand side. Alternative configurations are indicated for each of the upper and lower printing machines and for the inking and dampening systems 14; 20, which are interchangeable with each other.

In the embodiment shown in FIG. 8, all nine cylinders 16; 17; 18 are each driven by their own drive motor 61, each of which drives the respective cylinder 16; 17; 18 through a gearbox 62. The ink train 14 shown in FIG. 8 is fitted with two friction rollers 63 as well as with other rollers that are not specifically shown. The friction rollers are driven by their own common drive motor 64. The two friction rollers 63 can be moved and driven, in an axial sense, by a drive train, which is not shown. The ink train 14 shown below has only a single friction roller 63. The upper dampening system 20 is fitted with two friction rollers 66 as well as with other rollers that are also not shown. The friction rollers are driven by their own common drive motor 67. The two friction rollers 66 can be moved and driven, in an axial sense, by a drive train, which is not shown. The lower dampening system 20 has only a single friction roller 66. In a variation of the present invention, which is indicated in the upper printing machine by dotted lines, the ink train and/or the dampening system 14; 20 is not driven by its own drive motor 64; 67, but takes a rotary drive from the rollers 16; 17; 18, in particular from forme cylinder 16 by the use of a mechanical coupling, using for example, gears and/or belts.

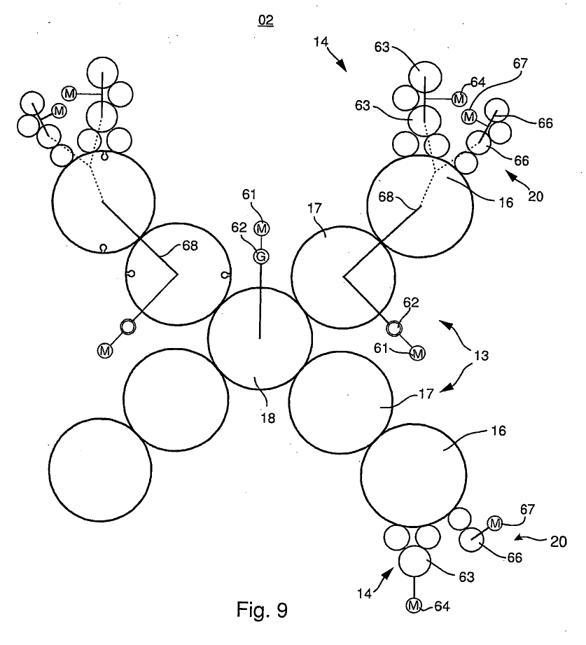

In contrast to the configuration depicted in FIG. 8, both the cylinders 16; 17 of each printing machine 13, in the arrangement shown in FIG. 9, are driven by a common drive motor 61, which is arranged initially acting on the transfer cylinder 17. The drive can be arranged axially, such as by using a gearbox 62, or can be accomplished by a pinion gear driving a drive gear on the transfer cylinder 17. The drive gear on the transfer cylinder 17 can then drive a further drive gear on the forme cylinder 16. The drive linkage 68, as shown as a dotted line in FIG. 9, can take the form of gearing or a belt drive, and, in a further development, is encapsulated. The arrangement used for the drive of the ink train and for any necessary dampening system 14; 20, whether using their own drive motors 64; 67, or having a drive derived from a cylinder 16; 17; 18, should always be as shown in FIG. 8.

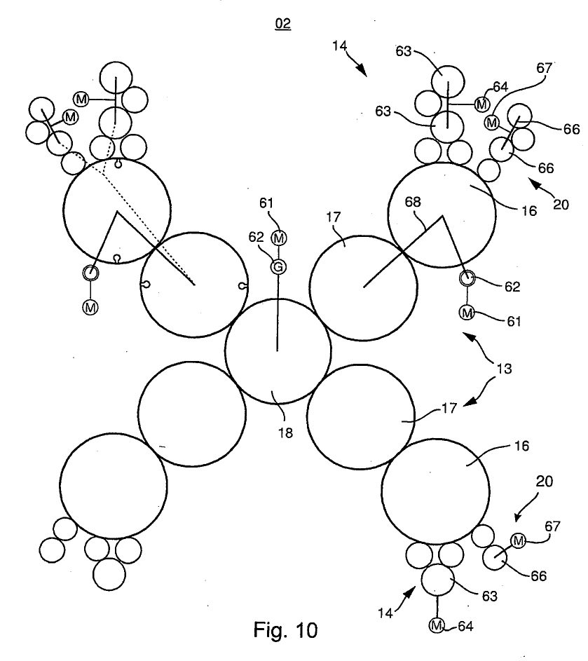

In contrast to the configuration depicted in FIG. 9, both the cylinders 16; 17 of each printing machines 13, in the arrangement shown in FIG. 10, are driven by one common drive motor 61, which initially drives the form cylinder 16. Once again, the drive can be arranged axially, such as by using a gearbox 62, or can be accomplished via a pinion gear driving a drive gear on the forme cylinder 16. The drive gear on the forme cylinder 16 can then drive a further drive gear on the transfer cylinder 17. The drive linkage 68 can be arranged as shown in FIG. 9. The arrangement used for the drive of the ink train and for the drive of any necessary dampening system 14; 20, whether using their own drive motors 64; 67 or derived from a cylinder 16; 17; 18 should once again always be as shown in FIG. 8.

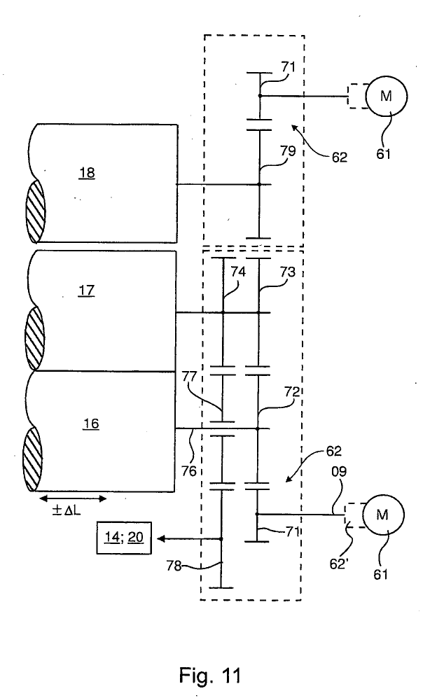

In contrast to the arrangement depicted in FIGS. 8 and 9 by the dotted line showing the ink train and/or dampening system 14; 20 without their own rotary drives, it is however advantageous, in a further development, to drive the ink train and/or the dampening system 14; 20 from the transfer cylinder 17. This allows a definite instantaneous flow rate to be achieved and avoids any irregularities arising from change of flank from one gear tooth to the next. An arrangement of this type of drive train is shown schematically in FIG. 11.

Through a pinion gear, as seen in FIG. 11, drive motor 61 drives a drive gear 72 that is rotationally firmly connected to forme cylinder 16, which, in turn, drives a drive gear 73 that is rotationally firmly connected to transfer cylinder 17. Either the drive gear 73 is a wide type, or a second drive gear 74 is attached to the transfer cylinder 17. The wide or the additional drive gear 73; 74 drives through a rotary drive gear 77 which is mounted on a journal 76 on forme cylinder, to a drive gear 78 for the ink train and/or the dampening system 14; 20. The drive gears 72; 73; 74; 77; 78 are preferably spur gears. For the case that forme cylinder 16 is shiftable for adjusting the axial position by, for example ±ΔL, at least the pinion 71 and the drive gears 72 thro 74 should be straight toothed. Between drive motor 61 and the gearbox from pinion 71 and drive gear 72 an additional encapsulated ancillary transmission gearbox 62′ can be fitted, which is indicated here by a dashed line. The drive to forme cylinder 16 can also alternatively be axial, by use of journal 76, which allows an axial movement of the forme cylinder 16 using an axial relative movement, not shown, between the forme cylinder 16 and the coupling at the output from drive motor 61. The satellite cylinder 18 in this arrangement is also driven by a pinion 71 to an associated drive gear 79, in particular spur gear 79. Each drive train is driven by an independent drive motor 61. In an advantageous arrangement, at least for those drive trains, in smaller units, are encapsulated units, shown as a dashed line in FIG. 11.

The arrangements described for the offset tower 02 and for the printing machine 13 and their associated cylinders 16; 17; 18 and their drives allow low-vibration, precision registration printing of a high quality with a low technical requirement. This can be done in a small space and is coupled with the achievement of product excellence.

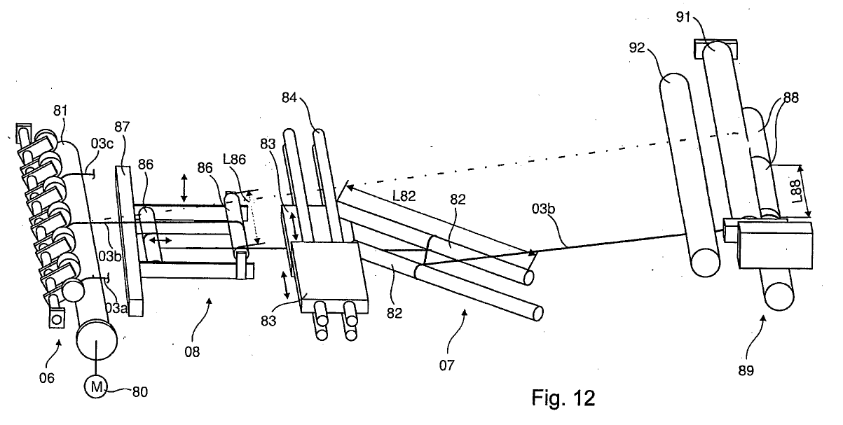

After web 03 has been printed with, for instance, six pages in width, this web 03 runs over guide elements and/or draw rollers, that need not be described in detail, into the area of the superstructure 04 where web 03 is fed, for instance, through longitudinal slitters 06, as seen in FIG. 12. These slitters 06 have, for instance, a roller 81, with, for instance, roller 81 being a draw roller driven by its own drive motor 80, which functions, together with the proof-pulling rollers, in order to avoid slippage. Longitudinal slitters 06 and draw rollers 81 can also be implemented separately from each other, in which case the longitudinal slitters 06 preferably operate in conjunction with another roller. In this arrangement of longitudinal slitters 06, the web 03 is divided into a multiple, such as, for example, three, partial web-width webs 03a; 03b; 03c, which will be referred to, for briefness, as partial webs 03a; 03b; 03c, and which are symbolically indicated by their centre lines, lines 03a, 03b, longitudinally slit before these partial webs 03a; 03b; 03c following guide elements, such as rollers for register controls 08, turn rods for turn units 07, run-on rollers for intake to former folders or draw rollers. To achieve a relatively vibration-free web transport relative to the web tension, all of the guide elements, either individual, multiple, undriven or simply driven by friction with webs 03a; 03b; 03c, which guide elements are provided for guidance of the partial webs 03a; 03b; 03c, shall be of a reduced length. Compared to the requirements for a web width of six printed pages, this allows a substantial reduction in length and strength of the guide elements, because the load-bearing capacity is much less. The risk of vibrations, especially in the event of changes of speed, which vibrations otherwise would arise, is effectively reduced, which, in turn, avoids the negative consequences for registration precision and print quality that would otherwise occur. The following arrangements for guidance elements of reduced length, for lateral position change capability, and for arranging a register roller with another guide element can be used on a wide variety of printing machines, but above all can be used with particular advantage on machines that are six plates wide.

FIG. 12 shows an isometric view of a first preferred arrangement for at least a part of the superstructure 04. The arrangement shown in FIG. 12 depicts the partial web 03b turning outwards from the center. A second one of the partial webs 03a; 03c; could, for instance, by use of a second turn unit 07 of this type be directed into another direction. A second turn unit can, for example, be placed above or below the first turn unit 07.

The turn unit 07 has, as the guide element 82, the usual arrangement of two parallel or crossed turn bars 82, which form an angle of approx. 45° or 135° to the incoming partial web 03a; 03b; 03c, and by the use of which, an incoming web 03a; 03b; 03c can be laterally displaced and/or inverted. The turn bars 82 exhibit advantageously a length L82, the projection of which length onto the crosswise dimension of the incoming partial web 03a; 03b; 03c is very slightly greater, for instance between 0% and 20% greater, than the width of the incoming partial web 03a; 03b; 03c. That is, the length L82 is approx. 1.4 to 1.7 times that of the partial web. At least the length L 82 is chosen to be such that its projection is less than, or is equal to twice the width of one of the two page partial web 03a; 03b; 03c, so that the length L82 is, at most, 2.8 times the width of the partial web. In an advantageous further development, the turn bars 82 are each mounted on carriers 83, which are positioned crosswise to the incoming partial web 03a; 03b; 03c and whose location can at least be moved by the use of a guide 84. The “short” turn bars 82 can now be brought into the necessary position according to the requirements of the desired web. In some circumstances, both turn bars 82 can be mounted on this type of carrier 83.

Displaced, turned, overlaid and/or inverted partial webs 03a; 03b; 03c experience, in comparison to other partial webs 03a; 03c, as a rule, a displacement of their direction of travel and therefore must be corrected in the longitudinal register by the use of a register control 08. The register control 08 has a guide element 86 with at least one moveable roller arranged parallel to the direction of travel. The roller 86 or several rollers 86 of the register control 08 advantageously have a length L86 which is very slightly greater, for instance which is between 0% and 20% greater, than the width of the incoming partial web 03a; 03b; 03c. At least the length L 82 is less than or is equal to twice the width of one of the two page partial web 03a; 03b; 03c. In an advantageous further development, the register control 08 is mounted crosswise to the incoming partial web 03a; 03b; 03c on at least one guide 87 whose location can be moved. The register control 08 is now narrow and, together with its short roller 86, can now be brought into the necessary position according to the requirements of the desired web routing.

As well as the slitters, and any necessary turning devices or registration devices, the partial webs 03a; 03b; 03c are fed over other undriven guide elements, such as guide rollers which are not specifically shown, before they are fed into the run-in rollers or harp rollers 89 of what is called the harp 09, which is shown schematically in FIG. 1 and which is situated in front of the former folder 11. For the webs 03 that run straight through, and for partial webs 03a; 03b; 03c, there is, in the superstructure 04 upstream from the harp roller 89, for instance a register roller 91 and a diverter roller 92 that are arranged across the full web width b03, and whose position can be varied along the transport direction.

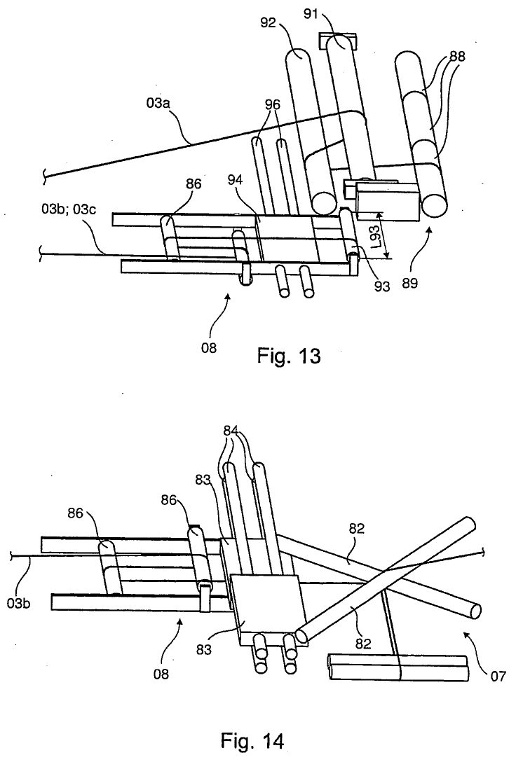

In an advantageous arrangement, the length of a guide roller and/or of a harp roller 88 is L88; L93 is very slightly greater, for instance between 0% and 20% greater, than the width of the incoming partial web 03a; 03b; 03c. At least the lengths L 88; L93, shown in FIG. 13, are less than or are equal to twice the width of one of the two page partial web 03a; 03b; 03c. In the example shown in FIG. 12 the “short” harp roller 88 is split into sections 88, however, in total, it constitutes harp roller 89 whose total width is sufficient for a web 03 whose width is six printed pages. The sections of the harp roller 88 are each free to rotate independently.

The “short” harp roller 88; 93, functioning as guide element, can however be fitted instead of, or in addition to a section 88, even, as shown in FIG. 13, implemented as an individually mounted harp roller 93 in its own frame. This can either be fixed in the frame or also on a carrier 94 or on a guide 96 positioned crosswise to the direction of travel of the incoming partial web 03a; 03b; 03c with sufficient scope for local adjustment.

Since the displacement on turning displacement, inversion etc, applies only to these partial webs 03a; 03b; 03c and is connected with their special routing, in an advantageous arrangement, the necessary register control 08 can be arranged in combination with one or more of the guide elements for the routing of the partial web 03a; 03b; 03c, such as the turn unit 07 or one of the turn rods 82 or the harp 09 or a “short” harp roller 93.

In FIG. 13 for instance the “short” register control 08 is arranged in combination with the “short” harp roller 93 and then can be adjusted together with this “short” harp roller for position using the guide 96 which is arranged crosswise to the incoming partial web 03b; 03c.

In FIG. 14 for instance, the “short” register control 08 is arranged in combination with one of the “short” turn bars 82 and then can be adjusted together with this “short” turn bar 82 for position using the guide 84 which is arranged crosswise to the incoming partial web 03b. This arrangement is here shown for crossed turn bars 82, but it could equally well be used for parallel turn bars 82, as shown in FIG. 11. For the case that turn bars 82, which are crossed or which are orthogonal to each other, are used, at least one, and here two diverter rollers 97 are used with axes of rotation perpendicular to that of the axis of rotation of roller 81.

In an advantageous further development, one of the 3-page width printing machines in the superstructure is assigned to the entire web 03 two of this sort, with register control and turn units 08; 07 or with register control and harp roller 93 joint positional adjustment “short” device one above the other.

The guides 84; 96, shown in FIGS. 13 and 14, for the arrangement examples described above, can be implemented in a wide variety of different ways. For instance, the guides 84; 96 can be arranged as spindles with at least sectioned threads, which spindles are mounted on both sides and which can be turned, and can be driven with a rotary drive, which is not shown. The carriers 83; 94 can be arranged as sort of sliding chocks also in a rigid guide 84; 96, for instance as profiles. In this way, a drive for the carrier 83; 94 can also be provided using a driven spindle or otherwise.

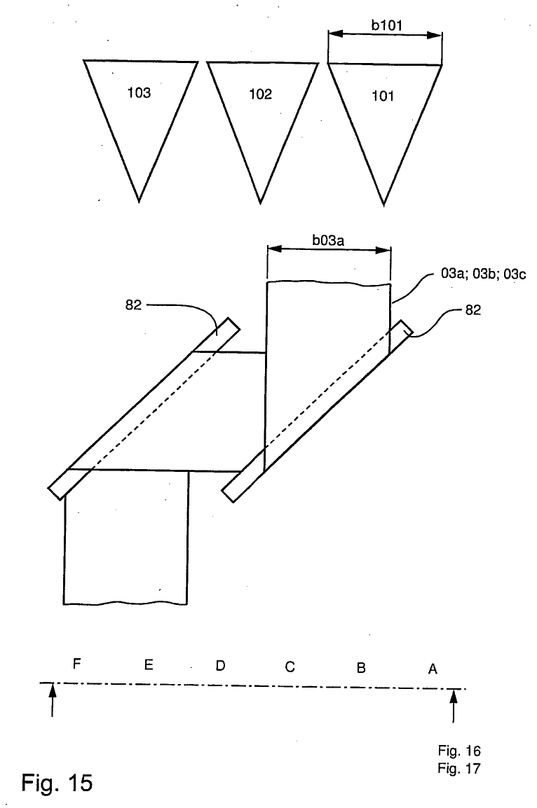

In the center of the adjustable position turn bar 82 there can be variable overlaps and displacements of partial webs 03a; 03b; 03c over one or two partial web widths, or also multiples of half a partial web width. In such cases, the printed partial webs 03a; 03b; 03c are each aligned with one of several, here three, former folders 101; 102; 103, as shown in FIG. 15 of the folder structure, which are arranged alongside one another crosswise to the direction of travel. The transfer must permit, for instance, the requirements of different thicknesses in the individual ribbons and must correspond to semi-finished and to finished end products, while at the same time permitting effective printing of the fullest possible web width.

For n webs 03; 03′ to be printed in, for example n print towers 01, each of a maximum width b03 of m printed pages, the superstructure 04 has, in an advantageous arrangement, at least (n*(m/2−1) turn units 07. In the case of a six page width printing machine with, for instance, three webs 03; 03′, and three print towers 01 per section, there are advantageously six turn units 07 per section.

In an arrangement of the printing machine with, for instance, two sections each of three print towers 01 and in total six webs 03; 03′; 03″ each web being four printed pages wide and arranged for four-color printing on both sides, there are at least three turn units 07 provided per section.

In an advantageous arrangement of a printing machine with, for instance, two sections each of two print towers 01 and in total four webs 03; 03′; 03″, each being four printed pages wide for four-color printing on both sides, there are four turn units 07 provided per section. In the printing machine with two sections, a total of four print towers 01, and four webs 03; 03′, the combined operation can yield a product with a total thickness of, for instance, 96 pages. As well as the displacement of a partial web 03a; 03b; 03c by a whole number multiple of its partial web width b03a, an advantageous operating mode is possible whereby a partial web 03a; 03b; 03c is displaced by an odd number multiple of a half partial web width b03a and/or former folder width, such as by a factor 0.5; 1.5; 2.5, as seen in FIG. 15. This can be done by the use of long turn bars which are not shown and which extend over the entire width of the printing machine or over the width b03 of the entire web 03, but also can be done advantageously by the locally adjustable “short” turn bars 82 described above. The turn bars 82 are then, for example, arranged as shown in FIG. 15, so that the first turn bars 82 enclosed by the partial web 03a; 03b; 03c are aligned at least with the entire width of the following former folder 101; 102; 103, while the second turn bar 82 is at least aligned with the neighbouring halves of the two following former folders 101; 102; 103 which lie alongside each other.

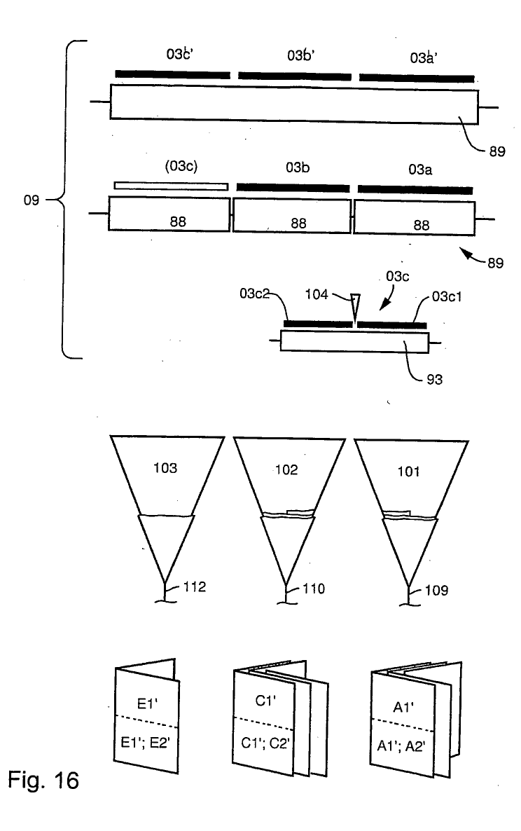

The partial web 03a; 03b; 03c, which is displaced by an odd number multiple of a half former folder width b101 or by partial web width b03a, thus runs “between” the former folders 101; 102; 103. This is shown in FIGS. 15 and 16 in the example of a folder structure with a width of six printed pages on a partial web 03a; 03b; 03c with a width of two pages. However, this can also be applied to machines of other widths. Therefore no partial webs 03a; 03b; 03c with a width of a single sheet or partial webs 03a; 03b; 03c with a width of half a former folder can be printed and fed through the machine. A higher multiple of the product is however possible.

The partial web 03a; 03b; 03c, which is displaced by an odd number multiple of a partial web width b03a or of a partial web width b03a, will be longitudinally slit before it reaches the former folders 101; 102; 103 by the operation of slitters aligned between the two matching former folders 101; 102; 103, following which it runs on to the folder structure 11 or to the harp 09, i.e. split or not split harp roller 89 and/or “short” harp roller 93, as depicted in FIG. 16.

In FIG. 16 a schematic section of FIG. 15 is shown with examples of different harp rollers 89; 93, whereby, for example, the partial webs 03c is displaced from its original position, shown incomplete, by one-and-a-half partial web widths b03a. It can, for example if the product is cut with a further longitudinal slitter 104 ahead of the former folders 101; 102; 103, which must always be a printed page or a newspaper page width wide, in each case be split into two halves thereby forming the partial webs 03a and 03b which each are fed to a former folder 101; 102. Both the semi-finished products then each have, for instance, a partial web width 03c1; 03c2 of at least a printed page in width from what previously was a partial web 03a; 03b; 03c of two printed pages width. In addition, partial webs 03a′; 03b′; 03c′ can be brought in, for instance as printed webs 03′ from another print unit 02 or from another print tower 01 to run onto one or more of the harp rollers 89; 93. The partial webs 03a, 03a′, 03c1; 03b, 03b′, 03c2 can now each, for instance, be collated into a ribbon 109; 111; 112 on the same alignment and can be fed to a former folder 101; 102; 103. In the example shown, from two printed webs, each having been double sided printed in double size and triple width print units, such as four-color 03; 03′ products or semi-finished products, which are also called volumes or books, with the following, in accordance with the mounting of form cylinder 16 and the corresponding mode of operation of folder structure 12, a different number of pages can be produced. In simple production, wherein the forme cylinder 16 is mounted, in the circumferential direction, with two print formes 19 of different printed pages A1, A2 through F1, F2, or A1′, A2′ through F1′, F2′ for the second web 03′, and in the folder structure 12 they are transversely folded and are collated so that the ribbons 109 and 111 can each produce two different volumes, each of 10 printed pages, and the ribbon 112 can produce two different volumes, each of four printed pages. A total product then has 48 pages. If this printing machine is used in double production, wherein the forme cylinder 16 is mounted with two print formes 19 of the same printed pages A1, A1; through F1 or A1′, A1′ through F1′, F1′, and in the folder structure 12 they are not collated, then the ribbons 109, 111 and 112 each produce two identical volumes, each of the above numbers of pages. A total product has then only 24 pages, but it is produced at twice the rate of output.

The harp rollers 89; 93, in particular if they are not split over the whole length, can, in a further development, be driven separately by their own drive motors, which are not shown. These motors can then be adjustable, for instance, with respect to their speed of rotation and also in their position, and can thus be specified in the machine controls or by using electronic control in relation to a master reference axle.

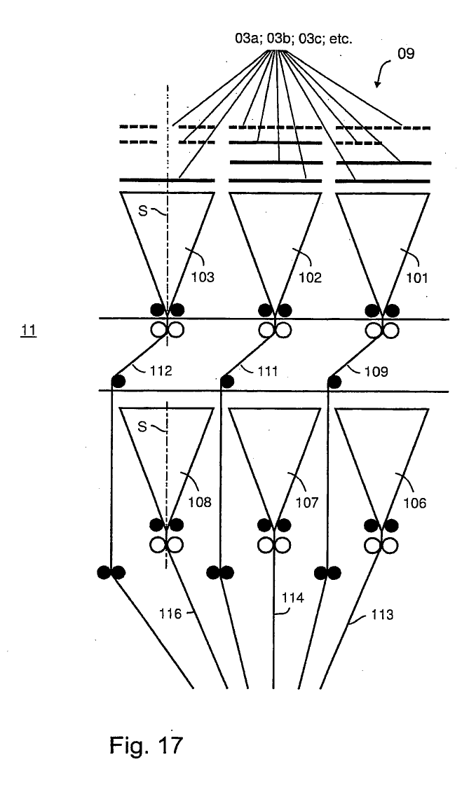

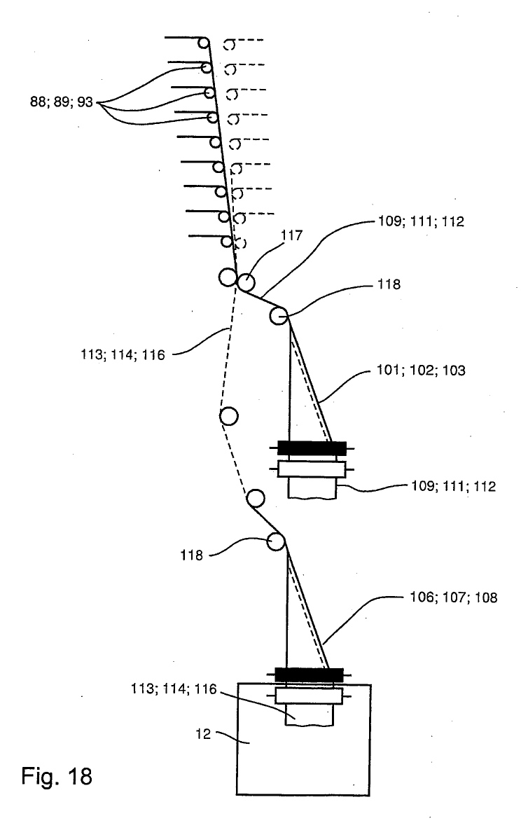

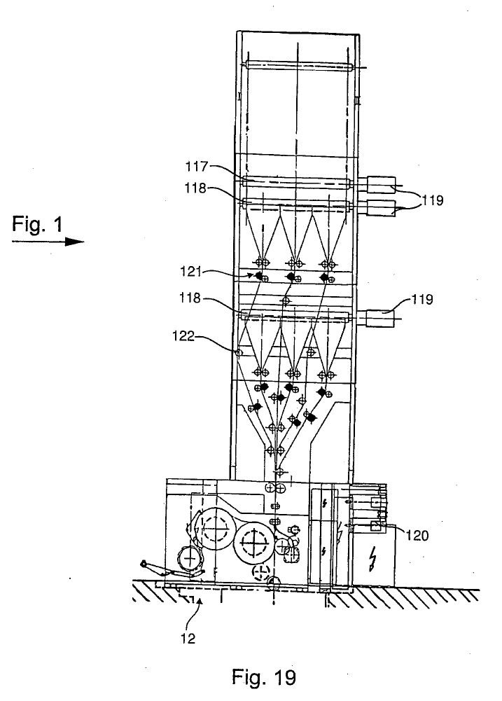

As shown in FIG. 17, the folder structure 11 exhibits at least two former folders 101; 106; 102; 107; 103; 108 located one above the other, whose plane of symmetry S is aligned with the partial web 03a; 03b; 03c that runs, in a straight line, from one of the printing machines. In particular, the planes of symmetry S of both the former folders 101; 106; 102; 107; 103; 108 that lie one above the other largely coincide with a centre line plane M of a partial web 3a; 3b; 3c (3a′; 3b′;3c′ or 3a″; 3b″; 3c″ or 3a′″; 3b′″; 3c′″ etc.) which is two page widths wide and which is diverted only in the vertical sense. In FIG. 18 some of the partial webs 3a; 3b; 3c etc. are drawn in solid lines and some are shown with a dashed line to another part, for reasons which will be explained below.

For printing machines that are six printed pages wide, there are arranged two vertically offset groups each of three former folders 101; 102; 103 or 106; 107; 108 as shown in FIG. 17. For four printed page widths, there can be two former folders alongside each other, and for eight printed page widths there can be four former folders alongside each other. Each pair of an upper and a lower former folder 101; 106; 102; 107; 103; 108 are aligned as a pair, in the style and method described above, to a center plane M. The three former folders 101; 102; 103 or 106; 107; 108, or a group, are displaced transversely to the direction of travel of the partial webs 03a; 03b; 03c, and, in an advantageous arrangement, are arranged to be essentially at the same height. They can however, if necessary, be displaced vertically with respect to each other and/or can be at various vertical heights, allowing them to partially overlap each other in the horizontal plane.

As seen in the direction of travel of the webs, before the folder structure 11, or at least before one of the groups of former folders 101; 102; 103 or 106; 107; 108 situated one above the other and which lead into the former folder for the webs 03; 03′; or the partial webs 03a; 03b; 03c. with the fixed harp 09, there is a group of several parallel run-in or harp rollers 89;93 which are displaced in a radial sense to each other, and over which the different webs 03; 03′; or the different partial webs 03a; 03b; 03c or 03a′; 03b′; 03c′ etc. from the superstructure 04 are fed before reaching the folder structure 11. For the harp rollers 89; 93, the webs are collated into a ribbon 109; 111; 112 or into several ribbons 109; 111; 112. The subsequent position of the partial webs 03a; 03b; 03c or 03a′; 03b′; 03c′ within ribbon 109; 111; 112 and the printed pages in the semi-finished or finished end product, can be changed by the relative positions of the partial webs 03a; 03b; 03c or 03a′; 03b′; 03c′ within the harp 09. The harp rollers 89; 93 of a harp 09 are displaced from each other vertically and/or horizontally and are preferably constructed as an assembled module which is mounted in a common frame. In principle, a harp of this type is provided for each of the vertically displaced groups of former folders 101; 102; 103 or 106; 107; 108.

A saving can be made in the height required for the printing press by an advantageous arrangement, as shown in FIGS. 1 and 19, where both the two former folders 101; 106; 102; 107; 103; 108 that are mounted above one another, and which are located in the same plane of symmetry, have a common harp 09. For n full webs 03; 03′ to be printed by, for example n print towers 01 of a section, of a maximum width b03 of m printed pages, the harp, in an advantageous arrangement, has at least (n*m/2) harp rollers 88; 89; 93, whose axes of rotation, for instance, largely lie in a common plane, and which harp rollers are preferably mounted in a common frame. In the case of a printing machine which is six page widths wide, and, for instance with two webs 03; 03′ and two print towers 01, there are advantageously at least six harp rollers 88; 89; 93 for each harp.

In an arrangement of one section of the printing machine, with three print towers 01 and with three partial webs 03; 03′; 03″ for accomplishing four-colour printing on both sides of a web 03, there are at least nine harp rollers 88; 89; 93 provided per harp 09. In this section, in collation operation, a product with a total thickness of, for instance, 72 pages can be produced.

In an advantageous arrangement of a printing machine with, for instance, two sections, each of two print towers 01 and with a total of four partial webs 03; 03′; 03″, each being six page widths wide, for four-color printing on both sides, there are at least six harp rollers 88; 89; 93 provided per harp 09 in each section. These six harp rollers 88; 89; 93 per section, for a total of twelve harp rollers, can be arranged to run through two separately mounted harps 09, over a common folder structure 11 or two folder structures 11, or also in two alignments through a harp 09 within a single frame. In this printing machine with two sections, with a total of four print towers 01 and four webs 03; 03′ then in collating operation a product with a total thickness of, for instance, 96 pages can be produced.

In an arrangement of a printing machine with, for instance, two sections each of two print towers 01 and with a total of four partial webs 03; 03′; 03″ each of six page widths wide for four-color printing on both sides there are at least six harp rollers 88; 89; 93 provided for each harp 09 in each section. These six harp rollers 88; 89; 93 for each section, for a total of twelve harp rollers, can be arranged in two separately mounted harps 09, for example over a common folder structure 11 or over two folder structures 11, but also in a common frame harp 09 in two alignments. In this printing machine with two sections, with, for example, a total of four print towers 01 and four webs 03; 03′ then, in collect or collating operation, a product with a total thickness of, for instance, 96 pages can be produced.

If only one folder structure 11 is provided for two sections, then the number of harp rollers 89; 93 required is determined for the configuration of the sections. If the folder structure 11 is positioned between the two sections, then either all the harp rollers 89; 93 should be arranged in the same alignment, or, to save installation height, the harp rollers 89; 93 for each section can be each placed in their own alignment and the two alignments can be displaced horizontally, in a radial sense, relative to each other. The harp rollers 89; 93 of the two alignments should, in this case, both be arranged within a common frame.

If, as shown in FIG. 1, there are, in fact, two folder structures 11 provided for the two sections, it can nevertheless be advantageous for at least one of the two harps 09 to be provided with a number of harp rollers 89; 93 in both of the above-mentioned alignments, which are necessary for the two sections. This allows a great degree of flexibility in production thicknesses and in compilations. The webs 03; 03′ printed in one section can now, if needed, be routed for further processing through the harp 09 of the other section, and vice versa.

As shown in FIG. 18, at least one of the partial webs 03a; 03b; 03c which run through the common harp 09 ahead of the upper former folders 101; 102; 103 can be directed to run through the lower former folders 106; 107; 108. According to the thickness desired for the individual semi-finished product, such as volumes, or books a greater or lesser number of the partial webs 03a; 03b; 03c can be changed over from the upper former folders 101; 102; 103 to the lower former folders 106; 107; 108. In accordance with production requirements, this allows different thicknesses of ribbons 109; 111; 112; 113; 114; 116 to be run either to the upper former folders 101; 102; 103 or to the lower former folders 106; 107; 108. For instance, the partial webs shown as dashed lines in FIG. 17 as ribbons 113; 114; 116 are arranged to run through the lower former folders 106; 107; 108, and the partial webs shown as solid lines are arranged to run through the upper former folders 101; 102; 103. The “dividing line” between the partial webs 03a; 03b; 03c which lie above one another from the common harp is flexible, so that thicker semi-finished products, such as volumes, or books, or finished products require reduced effort to set up. In FIG. 18, a second alignment of harp rollers 89; 93 is shown as a dashed line, be the use of which, the partial webs 03a; 03b; 03c described above can, for instance, be taken from a different section.

In the case of multi-color production, it is advantageous, from the point of view of flexibility, when using the folder structure 11 with a common harp, as described above, that all printing units 02 or print towers 01 and the webs 03; 03′ all have the same color capability as each other. So, for instance, the web 03; 03′ and the partial webs 03a; 03b; 03c etc. and also the printing machine 13 can be selected flexibly for a colored cover sheet, and the thickness of the semi-finished product can be variable.

The above-mentioned folder structure 11 with only a single harp 09 for two former folders 101; 106; 102; 107; 103; 108 is also suitable for other printing machines with other cylinder widths and cylinder circumferences. A folder structure of this type, comprising two former folders 101; 106; 102; 107; 103; 108 arranged one above the other and having a common harp 09, can also be combined with a third former folder with its own harp 09. The folder structure 11 described with multiple vertically displaced former folders 101; 106; 102; 107; 103; 108 and an associated harp 09 can also be used to good effect on three former folders 101; 106; 102; 107; 103; 108 arranged one above the other.

External cover pages of, for example, an outer book can thus be routed via a particular web and/or a particular print tower/print unit.

The harp that is associated with multiple former folders 101; 106; 102; 107; 103; 108 allows the partial webs 03a; 03b; 03c which are arranged one above the other to be processed flexibly, according to the needs of the product, into different thicknesses of books, without requiring a major effort to arrange additional, superfluous displacements of partial webs 03a; 03b; 03c. So, for instance, from four partial webs 03a; 03b; 03c lying one above the other, in one case three webs can feed into one former folder 101; 106; 102; 107; 103; 108 and the other one web can feed in the other former folders 101; 106; 102; 107; 103; 108, while on another occasion two of the four partial webs 03a; 03b; 03c can be combined and can be fed into two of the former folders 101; 106; 102; 107; 103; 108. It is particularly advantageous that adjacent ribbons 109; 111; 112; 113; 114; 116 of different thicknesses can be combined, as shown in FIG. 17.

The draw roller 117 and the former folder feed-in roller 118 for the former folders 101; 106; 102; 107; 103; 108 each have, in an advantageous arrangement, their own drive motors 119, just as does the draw roller 121 for the folder structure 11, as seen in FIG. 19. In FIG. 19, the draw roller 117 for the lower group of former folders 106; 107; 108 is not visible. The respective drive motor 119 for the draw roller 121 is shown in FIG. 19 merely by an infilled area alongside the respective draw roller 121. Each of the former folders 101; 106; 102; 107; 103; 108 has, in an advantageous arrangement, at least one of these draw rollers 121 associated with it, which draw roller 121 works in combination with the proof-pulling rollers or with a single proof-pulling roller via ribbons 109; 111; 112; 113; 114; 116. In addition to this, the folder structure 11 advantageously has undriven guide rollers 122, over which guide rollers 122 the ribbons 109; 111; 112; 113; 114; 116, which are one printed page in width, can be fed.

It is particularly advantageous, for example in view of the need to set up and to maintain longitudinal registration, that the folder structure 12 has at least one drive motor 120 of its own, which is mechanically independent of the printing units 02. While the drive motors 119 of the draw roller 117 and of the former folder feed-in roller 117; 118; 121 of the folder structure 11 and/or of the driven draw rollers 81 of the superstructure 04 must merely be arranged to be controllable in respect of rotational speed and thus can be arranged to maintain a set angular relationship, the drive motor 120, in an advantageous arrangement, can be controlled and can be regulated with respect to its angular position.

This arrangement permits the print units 02 and folder structure 12, and their drive motors 61; 120, whose drives are mechanically independent of each other, to be linked with respect to their angular position by a virtual electronic reference axis. In another arrangement, the angular position of the folder structure 12, and its drive motor 120 are determined. Based on this, the angular position relative to the print units 02 and to the printing machine 13 to this is determined. The drive motors 80; 118 for the driven rollers 81; 117; 118 that are controlled merely by their angular speed receive their speed settings, for instance, from the machine controls.

By equipping the rotating roller printing machine with three times width and with double size transfer and forme cylinders and the corresponding arrangement of the folder structure, with a single web for instance in double production, there can be produced

a book of twelve pages

a book of four pages and a book with eight pages

two books with six pages

three books with four pages

together with further variations.

In collation or collection mode production, the numbers of pages can be doubled with semi-finished products in each case of two longitudinally folded sections.

For printing in tabloid format the respective numbers of pages can, in each case, be doubled. The dimensioning of the cylinders 16; 17; 18 and of the groups of former folders 101; 106; 102; 107; 103; 108 should be used for the respective “landscape” printed pages. So that in the circumferential direction, in the direction of running of the web 03a; 03′; 03a; 03b; 03c of a section A; B; C two flat forme pages are shown, the forme cylinder 16 can then therefore, for instance in one circumference, exhibit the equivalent of four landscape pages in tabloid format. The number of printed pages in the longitudinal direction remains on the web 03a; 03′; 03a; 03b; 03c, and cylinder 16; 17; 18 and the former folder width are maintained.

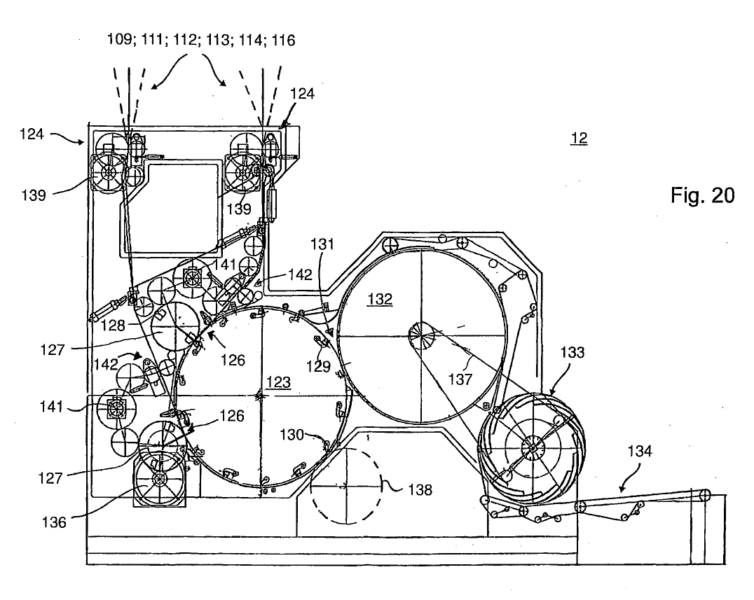

In a particularly advantageous arrangement of the three times width printing machine, as seen in FIG. 20, the folder structure 12 is provided with a transport cylinder 123, such as, for instance, a collection or collation and/or folding blade cylinder, which has a capacity for accepting more than five section lengths arranged in succession around the circumferential direction, and for providing a corresponding number of retainers 129.

Among other possibilities, three ribbons 109; 111; 112; 113; 114; 116 from three adjacent former folders 101; 106; 102; 107; 103; 108 can be fed simultaneously into the folder structure 12. However, up to six ribbons 109; 111; 112; 113; 114; 116 can be fed from different former folder groups, which ribbons then can be further processed into a product.

The transport cylinder 123 is provided with a large circumference, as described above, to permit correspondingly large movements for the actuation processes, such as cutting, holding, folding, which promote reliable operation at high production speeds. The larger radius of curvature has a further benefit of reducing markedly oblique cut edge that might otherwise be imparted to the product, especially for thick materials.

FIG. 20 shows a schematic side elevation of the folder structure 12. The folder structure 12 has at least one intake, and, in this case, has two intakes, for one or for several ribbons 109; 111; 112; 113; 114; 116.

Ribbons 109; 111; 112; 113; 114; 116 run though a pair of draw rollers 124 which regulate the tension. They then impinge on the transport cylinder 123 at the height of a cutting slot 126 and pass between the transport cylinder 123 on the one side and a cutter cylinder 127 on the other side. Instead of two intakes and two cutter slots 126 there can also be provided just one, or three, or four of these intakes and cutter slots 126.

The cutter cylinder 127 has a circumference corresponding at least to one, but preferably to two or more lengths of the signatures to be formed out of the webs 03; 04, and carries two cutter knives 128.

The folder structure 12 includes cutter cylinders 127 of this type, which are arranged around the periphery of the transport cylinder 123, and each of which carries two cutter knives. As shown, two ribbons 109; 111; 112; 113; 114; 116 or a bundle of ribbons 135 coming, for example from different former folders 101; 106; 102; 107; 103; 108, can be brought together in the folder structure 12 and can be fed into the two cutter slots to be cut separately before collection or collation into a product. The cutter knives 128, in an advantageous arrangement, are displaced slightly from 180° with respect to each other around the circumference, so that, when operating in collection or collation mode, the second cut avoids cutting the first signature a second time. Thus, the signature is cut shorter and the follow-through is left longer than half the circumference of the cutter cylinder 127. In this case, the length of the signature is considered to be the average of these several lengths.

Furthermore, the transport cylinder 123 has a displacement bar, which is not shown, in the area of its circumference between each of two transport grippers. This displacement bar has the effect, as it emerges from the face of the circumference, of shortening the signature in relation to the circumference. This allows the signature cut done by the second, lower cutter cylinder 127 to be performed without cutting, for a second time, the signature that has already been cut and which is lying on the transport cylinder, because it has been shortened by this displacement bar.

The circumference of the transport cylinder 123 is equivalent to more than five, and in particular to seven section lengths of the signature so that cylinder 123 is a “seven field transport cylinder 123”. On the transport cylinder 123, in the circumferential direction, there are provided seven recessed retainers 129 equally spaced one behind another, such as pinhole bars 129 for extendable pinhole needles, or a pinhole folding device. The retainers 129 can also take the form of grippers 129, such as a gripper fold device.

The signature cut off from ribbons 109; 111; 112; 113; 114; 116 having a cutter length, such as, for example a length of a portrait printed page, in particular a newspaper page are forwarded by the retainer 129 on to the transport cylinder 123.

On the transport cylinder 123 there are furthermore fitted seven fold knives or blades 130, each of which fold knife or blade, on reaching the gap 131 between the transport cylinder 123 and a flap fold cylinder 132, is moved outwards, so that the signatures transported on the transport cylinder 123 are passed on to the flap fold cylinder 132 in a particular way. These signatures are then folded. The folded products are passed from the flap fold cylinder 132 to a creel or a delivery cylinder 133 and from this are delivered to a discharge device 134, such as a conveyor belt 134.

Advantageously, the folder structure 12 can be operated, by its transport cylinder 123, in a choice between the options of a normal mode and a collection or collating mode of operation. In collection or collating mode, the transport cylinder 123 does not pass each signature or product cut-off on to the next cylinder on the first run through of the gap 131. Instead, it performs a further revolution with the same piece, when the retainers hold at least one further signature for passing on to the flap fold cylinder 132, before passing the signatures thus collected or collated in the gap 131 to the flap fold cylinder 132. In normal operation mode, the transport cylinder 123 always passes the signature on to the next cylinder 132 on the first run through of the gap 131. The transport cylinder 123 is a convertible arrangement and is fitted, in particular, with seven pinhole bars 129 in the circumference.

Cutter cylinder 127, transport cylinder 123 and flap fold cylinder 132 together with creel or delivery cylinder 133 as required are preferably driven by a single drive motor 136, which is shown schematically in FIG. 19 as drive motor 120, mechanically independent of the drives of the printing units 03, superstructure 04 and folder structure 11.

The arrangement shown in FIG. 20 shows the drive motor 136 but does not show the pinion or the gear wheel driving the cutter cylinder 127 or the gear wheels driving multiple cutter cylinders 127. The transport cylinder 123 and the flap fold cylinder 132 are driven by the cutter cylinder 127. A belt drive 137 is taken from the flap fold cylinder 132 to power the creel or delivery cylinder 133.

In another variant of the present invention, which is shown in FIG. 20 only as dashed lines, the transport cylinder 123 is driven by a drive motor 136, which is not shown in this case, through a pinion 138 and a drive gear 138, as shown in dashed lines. The cutter cylinder 127 and the flap fold cylinder 132 are driven by the transport cylinder 123. A belt drive 137 is taken, for instance, from the flap fold cylinder 132 to power the creel or delivery cylinder 133.

In both the cases described above, it is preferred that the discharge device 134 is driven by its own drive motor, mechanically independent of the drives of the cylinders 123; 127; 132 and the creel or delivery cylinder 133.

Cutter cylinder 127, transport cylinder 123 and flap fold cylinder 132 can also each be driven by their own drive motors, mechanically independent of the drives of the printing machines.

In another advantageous arrangement of the drives, the cutter cylinder 127, the transport cylinder 123 and the flap fold cylinder 132 are all driven by at least a common drive motor 136 or alternatively are each driven by its own drive motor 136, mechanically independent of the drives of the printing machines, while in a first variant the creel or delivery cylinder 133 and the discharge device 134 are driven by a common drive motor, which is mechanically independent of the drives of the cylinders 123; 127; 132 and the drives of the printing machines, and in the second variant each of the creel or collection cylinder 133 and discharge device 134 is rotationally driven by its own drive motor.

When the circumference of the transport cylinder 123 is equal to seven cutter lengths, it is possible, as described above, that twelve webs 03 and the corresponding number of partial webs 03a; 03b; 03c etc., for a total of up to seventy-two paper layers, and divided into up to six ribbons 109; 111; 112; 113; 114; 116, can be fed into the folder structure. Using a folder structure 12 without collation or collection operation, a product with a total of 144 pages, and in particular 144 newspaper pages, can be produced. If the folder structure 12 is configured for collation or collection operation, then using the six webs 03, the product can be, for instance, 14 pages, or, if more webs 03 are used, then products with even greater numbers of pages can be produced. For the last named product, the folder structure 12 can, for instance, be arranged for cylinder folding. However, the retaining devices 129 and the flap folds must be arranged to accommodate this number of layers.

It is advantageous in this respect, if the intake area for the pair of draw rollers 124 or for multiple pairs of draw rollers 124 are each fitted with at least one drive motor 139 of their own. This allows multiple ribbons 109; 111; 112; 113; 114; 116 to be collated in the intake area of the folder structure 12. In an advantageous further development, the folder structure 12, as shown, has two pairs of draw rollers 124, and the cutter cylinders 127 operate in conjunction with the transport cylinder 123. By this arrangement, in the intake area, two “bundles” can be collated from multiple ribbons 109; 111; 112; 113; 114; 116, and these two bundles can be fed, one after the other, to the transport cylinder 123 and can be cut separately from each other. These measures also contribute to the product thickness, as described above. By this arrangement, bundles of different or of identical numbers of ribbons 109; 111; 112; 113; 114; 116 can be fed into the two pairs of draw rollers 124; or simply all, or a certain number, of the total ribbons 109; 111; 112; 113; 114; 116 can be fed to one of the two pairs of draw rollers 124.

In the arrangement shown in FIG. 20, the folder structure 12 has a further draw group 142 which is driven by a drive motor 141, or if there are two intakes, there are two further draw groups 142 located ahead of the cutter gap 126. This is particularly advantageous if two cutter cylinders 127 are provided. The draw groups 142 are then spaced out, by the same distance, from the respective cutter gap 136 along the “bundle web”.

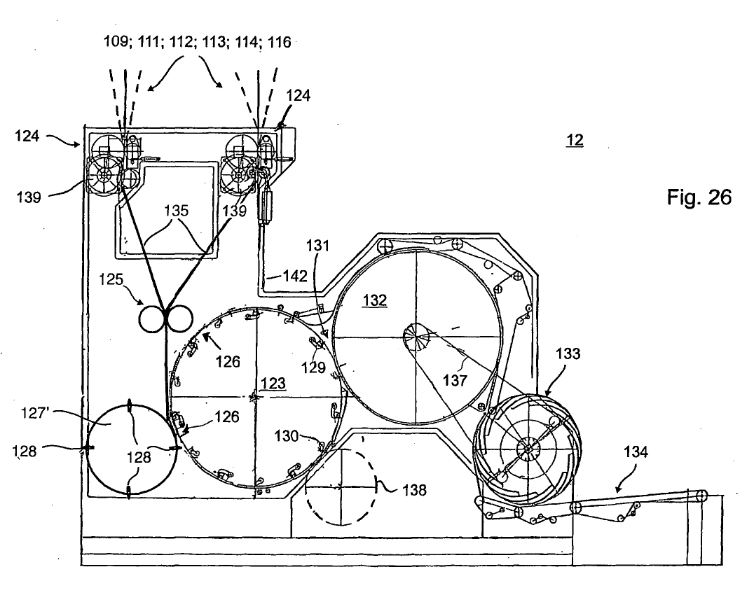

In an advantageous alternative arrangement of a folder structure 12, and particularly, but not exclusively for the folder structure 12 as depicted and described above, instead of the cutter cylinder or cylinders 127 with two cutter knives 128 mounted successively behind each other on the circumference this, this alternative arrangement has one cutter cylinder 127′ with four cutter knives 128 mounted successively behind each other on the circumference, as seen in FIG. 26. Two or more ribbons or bundles of ribbons 135 can, for instance, be collated by a roller or a pair of rollers 125, with their own drive motor, as draw group 125, or as undriven rollers or diverter rollers before entering the cutter gap 126. In FIG. 26, for the sake of simplicity, the detailed depiction of the remaining conveying system, such as drive motor 141, driven draw group 142 and the drive motor and drive train is omitted, whereby this advantageous, in one of the above mentioned, variants and without cutter cylinder 127, can be implemented. The circumference comprises four, central lengths of signatures to be produced from the webs 03; 04. As shown, again in the arrangement above, the cutter knives 128 are not equidistant around the circumference of the cutter cylinder 127′, but alternate between an angular segment somewhat greater than 90°, and an angular segment somewhat less than 90°, around the circumference.

The four cutter knives 128, and the four cut-off lengths or signatures around the circumference of the cutter cylinder 127′, such as a cutter cylinder with four-fold circumferential division, permit the use of significantly larger bearings, a greater journal strength and/or a heavier type of construction of the cylinder body itself, which all contribute to an increase in stability. This allows thicker products, with more layers, to be cut, since a greater force can be applied. For smaller thicknesses of product, the precision of cut can be increased due to the reduction in twist and/or in bending.

For fold machine or folder structures 12 for higher numbers of pages and for higher speeds, in addition to the centrifugal forces, the power available for pinhole punching or puncturing, for clamping or gripping and for cutting is also a critical parameter. The cutter cylinder 127′ with four-fold cutters is, for this reason, particularly advantageous because of its capability for cutting ribbons of great product thicknesses. This applies particularly to the printing machines described above with printing machines 02 that are three page widths wide and/or in conjunction with a seven-field transport cylinder 123. The arrangement, with four-fold division of the circumference, is however also useful apart from this. It can be used in any roller print machine and/or in conjunction with a multiple field, for example with five or seven field transport cylinders or cylinders of other formats, so as to achieve an increase in precision and/or product thickness capability. The cutter cylinder 127′ with four-fold cutters leads to a slight tilting of the cutter knife 128 when that cutter knife 128 is striking the cutter bar on the transport cylinder and the grooved rubber provided there, thus requiring reduced cutting power, or energy on force compared to a cutter cylinder 127 with two-fold cutters. The cutter pushes into the grooved rubber and then emerges from it at a significantly less angle of inclination of the cutter knife 128. Both the bending stress and the compression stress of the cutter knife 128 are thereby less, in total, than for knives on the cutter cylinder 127 with two-fold cutters.

With the arrangement of the cutter cylinder 127′ with four-fold cutters, and in spite of thicker products, a second cutter cylinder 127, with two-fold cutters on the circumference of the transport cylinder 123, can then be dispensed with.

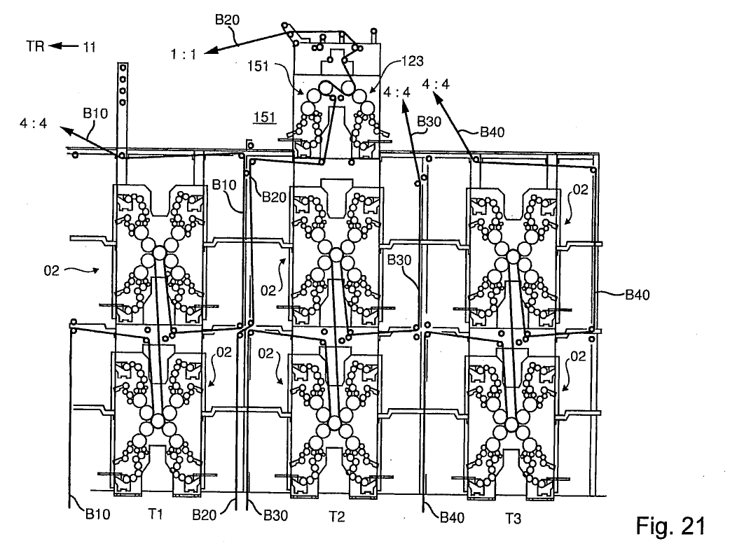

A great advantage can be achieved in a further development of the present invention, which is described below, of arrangements for the printing machine 13, the superstructure 04 mounted on it, the former folder 11, the folder structure 12 and/or the drive configuration, with respect of an arrangement of an additional printing press 152, with one or more additional printing presses 151, in particular with three-cylinder printing presses 151, and/or the advantageous routing of webs and or of printed products. In this context, see FIGS. 21 through 25, whereby functionally identical reference numbers are partially entered only in FIG. 21.

The additional printing press 151 or printing machines are advantageously corresponding to the printing units 02 as printing press 151 for indirect flat-bed printing, for which a transfer cylinder 17 is located between the printing position and the forme cylinder 16.

A print tower T1; T2; T3 is arranged with at least one additional printing unit 152 with at least a further printing position 151, i.e. with at least one printing position. In particular, at least two printing positions 151, 123 in one or in two additional printing presses 151 are assigned to the print tower T1; T2; T3. These are arranged in a common additional printing unit 152 or in separate additional printing units 152. These additional printing positions are advantageously positioned above the printing positions of the print tower T1; T2; T3. The print tower T1; T2; T3 advantageously has a total of eight printing positions, by the use of which, and depending on the web routing and expression of the printing presses 02 forming the print tower T1; T2; T3, one or more webs B10; B20; B30; B40 can be printed on one side or on both sides. The printing presses 02 of the print tower T1; T2; T3 are arranged vertically above one another and preferably should be implemented as satellite printing presses 02, all as shown schematically in FIG. 21.

At least two satellite printing presses 02 are additionally assigned, and are depicted as two printing positions, for example as two three-cylinder printing presses 151, by the use of which, for instance two webs B10; B20; B30; B40 that have been printed on only one side in the print tower T1; T2; T3 can be printed with a single color on the other side.

The two satellite printing presses 02 are linked to each other and are components of the print tower T1; T2; T3 and by the use of which, either two webs B10; B20; B30; B40 can be printed each in multi-color on one side or a single web B10; B20; B30; B40 can be printed in multi-color on both sides.

The two satellite printing presses 02 are arranged stacked one above the other. They are advantageously both nine-cylinder satellite offset printing presses. This again is depicted schematically in FIGS. 21 to 25.

A three-cylinder printing press 151 has a pair of cooperating cylinders, such as a forme cylinder 16 and a transfer cylinder 17 and also includes a counter-pressure cylinder 126 which operates in conjunction with them in an arrangement similar to the one shown in FIG. 2.

The two three-cylinder printing presses 151 can advantageously, considering the space requirement of units required be combined as a six-cylinder printing press 152, but can also be implemented as two individual units. It is also possible that only a single printing position, in the form of, for instance a three-cylinder printing press 151, can be provided, mounted above the print tower T1; T2; T3.

It is advantageous that the two three-cylinder printing presses 151, or the one six-cylinder printing press 152, are positioned above one of the last printing positions of the associated satellite printing presses 02. The six-cylinder printing press 152 is, for instance, arranged stacked above the associated print tower T1; T2; T3. It can however, depending on production requirements, be located stacked on another print tower T1; T2; T3, and in particular on an adjoining print tower, provided the web run to the print tower T1; T2; T3 is suitable.

The satellite printing presses 02 and the two three-cylinder printing presses 151 are arranged with respect of each other, and with web routing permitting, so that there exist as options a first operating mode where a web can run through both satellite printing presses 02, a second operating mode where the web can run through one of the satellite printing presses 02 and through one of the three-cylinder printing presses 151, and a third operating mode where the web can run only through both of the two three-cylinder printing presses 151.

The satellite printing presses 02 and the two three-cylinder printing presses 151 are also arranged with respect of each other, and with the web routing permitting, so that there exist as options a first operating mode where the first web can run through both satellite printing presses 02 and a second web can run through both the two three-cylinder printing presses 151, and a second operating mode where both webs can each run through one of the satellite printing presses 02 and through one of the three-cylinder printing presses 151.

In this way, two webs can be fed through the print tower T1; T2; T3 and the six-cylinder printing press 152, so that after printing, each web has been printed with multi-colors on one side, and with a single-color on the other side.

One of the two webs is, in this way, fed through the print tower T1; T2; T3, and the other web is fed only through the six-cylinder printing press 152, so that one web has been printed multi-color on both sides, and the other web has either been printed single-color on both sides, in a so-called S-routing or in two-color on one side in a so-called C-routing, which is not shown.

At least the printing machine has several print towers T1; T2; T3, each with two satellite printing presses 02 and, in addition, has at least one six-cylinder printing press 152.

The printing presses have at least two, and in particular have at least three print towers T1; T2; T3 adjoining each other in pairs, whereby at least one six-cylinder printing press 152 is stacked on one of the two, and in particular on one of the three print towers T1; T2; T3. Advantageously, there is no other processing stage positioned between the respective print towers paired to each other in the way described above. In particular, no folding operation and/or folding machine is so positioned. It is important, in this respect, that the further printing press 151 is located above the printing press 13 of the printing unit 02. Advantageously it is stacked on one of the print towers T1; T2; T3.

In the embodiment depicted in FIGS. 21-25, the printing machine has at least three print towers T1; T2; T3 adjoining each other in pairs, and whereby at least one six-cylinder printing press 152 is stacked on one of the three print towers T1; T2; T3. A common six-cylinder printing press 152 is assigned to the three print towers T1; T2; T3, which common six-cylinder printing press 152 is advantageously stacked on the middle of the three print towers T1; T2; T3.

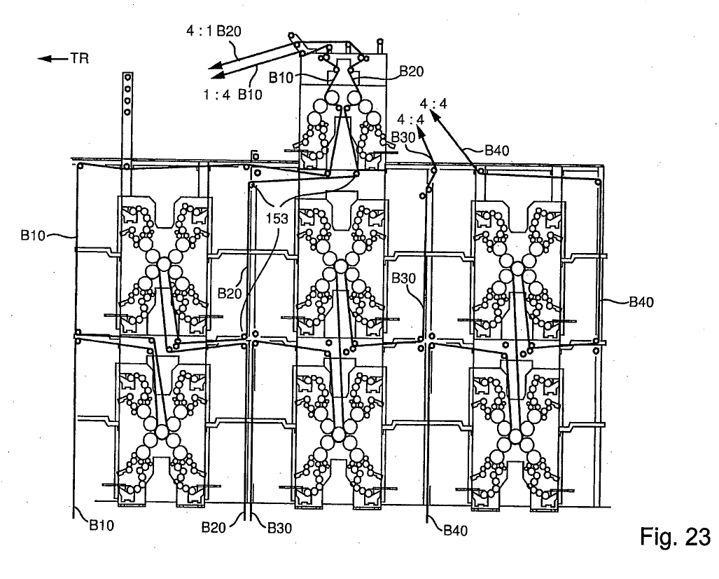

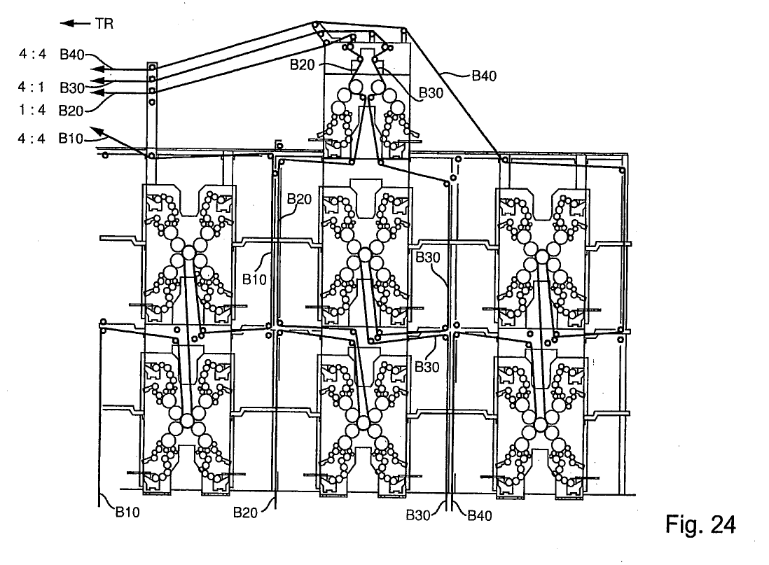

In this way for instance, three webs can run through at least two of the print towers T1; T2; T3 and the six-cylinder printing press 152, so that, after printing, two of the webs have been printed multi-color on one side, and in a single-color on the other side, and the third web is printed multi-colour on both sides, as seen in FIGS. 23, 24; 25.

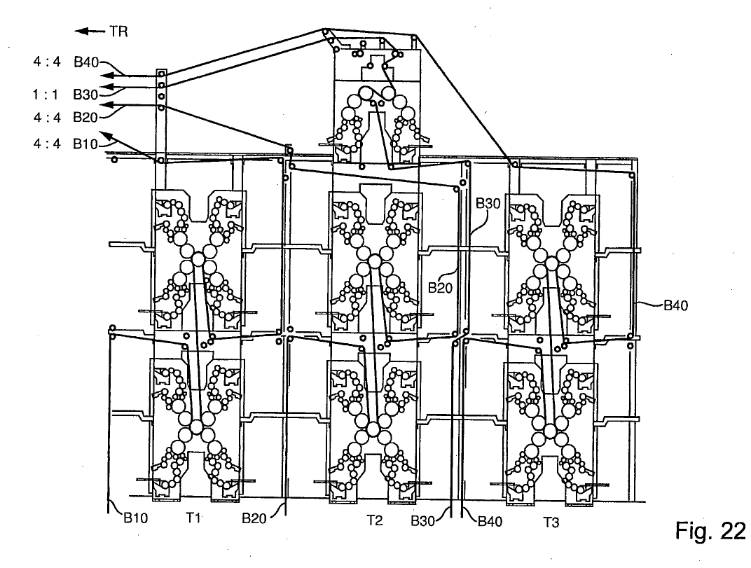

In an alternative web routing, two of the three webs are fed through at least two of the print towers T1; T2; T3 and a third web is fed through only the six-cylinder printing press 152. The two first mentioned webs are printed multi-color on both sides and the third web is printed single-color on both sides or two-color on one side, as shown in FIGS. 21, 22.

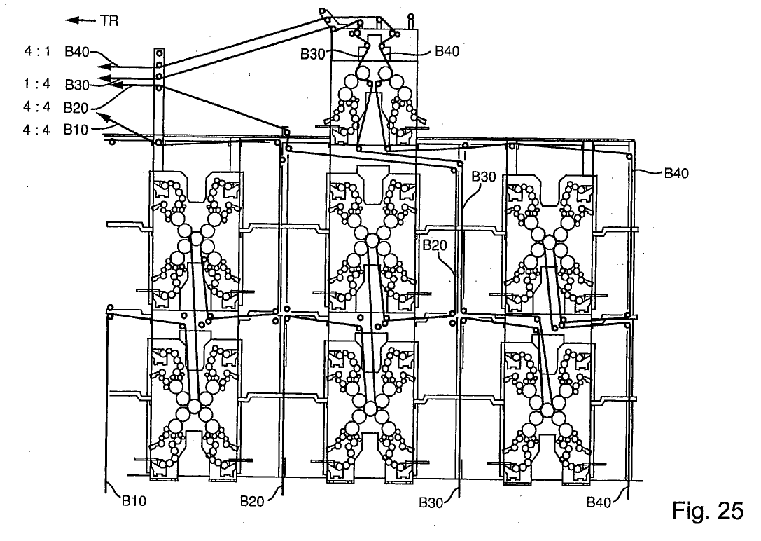

The printing machine has advantageously the capability, by the use of a diverter roller 153 and/or by draw webs, not shown, to guide the webs depending on whatever operation mode is chosen for the printing machine in this production mode and in the production modes made possible by the measures described above. FIG. 23 shows one possible example. In particular, diverter rollers 153 are provided, as shown for example in FIG. 23 for the web B20, which diverter rollers 153 permit routing of a web B10; B20; B30; B40 to the additional printing press 151; when the web has previously been printed in an adjoining satellite printing press 02 rather than in the printing press directly underneath it. Advantageously, in the case of two of the webs B10; B20; B30; B40 being routed to the printing press 151, these can have been previously printed in both the satellite printing presses 02 of the same print tower T1; T2; T3, as shown in FIG. 23: left, FIG. 24: center, FIG. 25: right.

In an advantageous embodiment of the present invention, four webs can be fed, in this way, through the three print towers T1; T2; T3 and through the six-cylinder printing press 152, so that two of the webs, after printing are each printed multi-color on one side, and single-color on the other side, and the other two webs are both printed multi-color on both sides, as seen in FIG. 23 through FIG. 25. In a different web routing, three of the webs are fed through the three print towers T1; T2; T3 and a fourth web is fed only through the six-cylinder printing press 152. The first-named webs are printed multi-color on both sides, and the fourth web is printed single-color on both sides, as seen in FIG. 21, 22, or two-color on one side, which is not shown. The printing machine has advantageously the capability 153, referred to above, to guide the webs depending on whatever operation mode is chosen for the printing machine out of the two or three operating modes listed above.

In the foregoing discussion, multi-color is to be understood as meaning four-color.

In one operating mode for the printing machine, the four webs with the three print towers T1; T2; T3 and with the six-cylinder printing press 152 are printed in such a way that both of the webs printed in multi-color on one side and in single-color on the other side, after printing are routed on a path to a former folder structure TR or to a former folder 11 so that they come to lie between the two webs that have been printed multi-colour on both sides, as seen in FIG. 24. The two webs printed multi-color on one side and single-color on the other side have, in this case, been fed through, for instance, the center of the three print towers T1; T2; T3 and the six-cylinder printing press 152.

In another operating mode, the four webs are printed by the three print towers T1; T2; T3 and the six-cylinder printing press 152 in such as way that the two webs printed multi-color on one side and single-color on the other side, after printing are routed on a path to a former folder structure TR underneath the two webs that have been printed multi-color on both sides, as shown in FIG. 23. The two webs printed multi-color on one side and single-color on the other side have, in this case, been fed through, for instance, the one of the three print towers T1; T2; T3 that is closest to the former folder structure TR, and through the six-cylinder printing press 152.

In another operating mode, the four webs are printed by the three print towers T1; T2; T3 and the six-cylinder printing press 152 in such as way that the two webs printed multi-color on one side and single-color on the other side, after printing are routed on a path to a former folder structure TR above the two webs that have been printed multi-color on both sides, as seen in FIG. 25. The two webs printed multi-color on one side and single-color on the other side have, in this case, been fed through, for instance, the one of the three print towers T1; T2; T3 that is furthest from the former folder structure TR, and through the six-cylinder printing press 152.

In these cases, the printing machine is advantageously also equipped with element 153 to guide the webs, depending on whatever operation mode is chosen for the printing machine, of the three last operation modes listed above.

The satellite printing unit utilizes several, and in particular has four pairs of cylinders each comprising a forme cylinder 16 and a transfer cylinder 17, and at least one satellite cylinder 18 operating in conjunction with one of the transfer cylinders 17. Advantageously, all four pairs of cylinders are each assigned a satellite cylinder 18 and are operating in conjunction. Another arrangement is to assign two satellite cylinders 18 to the four pairs of cylinders.

In one arrangement, the drives for two of the pairs are linked and are driven by a common drive motor 61 that is independent of the drive for the other drive train. For example the satellite cylinder 18, or one of the two satellite cylinder 18 is driven by a common drive.

It is advantageous however that a single satellite cylinder 18 can be driven at least by a drive motor 61 of its own, independent of the drive for the cylinder pairs including a forme cylinder and a transfer cylinder.

If there are two satellite cylinders 18, these should be driven at least by a common drive motor 61 of their own, independent of the common drives for the cylinder pairs.

In an advantageous arrangement, the cylinder pairs are each driven by at least a drive motor of their own, independent of the drives for the other pairs. Each cylinder of the cylinder pair can also have its own individual drive motor.

In a less expensive arrangement, the two cylinders of each pair are coupled and are driven by a common drive motor 61.

In another less expensive arrangement, the drive for an ink train 14 is taken from the drive for the respective forme cylinder 16. The ink train can also be driven by a drive of its own, independent of the drive for the form cylinder 16.

The additional printing press 151 exhibits a pair of cylinders, such as a forme cylinder 16 and transfer cylinder 17, and also a press cylinder or counter-pressure cylinder 18 that operates in conjunction with the transfer cylinder 17. The same applies for a second printing press 151, where this second printing press is provided. The print unit 02 used for this can be identified by the fact that it is the one for which the implementation example also depicts an indirect flat-bed print process with the corresponding functionality for its cylinders 16; 17; 18.

Correspondingly, the six-cylinder printing press 152 exhibits two pairs of cylinders each comprising a form cylinder 16 and a transfer cylinder 17, with each such cylinder pair having a satellite cylinder 18 operating in conjunction with it.

In the preferred arrangement of the present invention the pairs of the printing press 151 or of the six-cylinder printing press 152 are each provided with a drive motor 61 of their own, and which is independent of the other pairs.

Each cylinder of a pair can be driven by a drive motor of its own. In an advantageous arrangement, the two cylinders of each pair are coupled and are driven by a common drive motor 61, independent of the other cylinder pairs.

In a less expensive arrangement, the drive for the ink train 14 is taken from the drive for the respective forme cylinder 16. The ink train can also be driven by a drive of its own, independent of the drive for the forme cylinder 16.

In an advantageous arrangement, each counter-pressure cylinder is driven by a drive motor 61 of its own, independent of the drives for the cylinder pairs and independent of the drives of other counter-pressure cylinders. This is advantageous with respect to achieving independent positioning of the two printing presses.

If necessary, the two counter-pressure cylinders can be driven by at least one common drive motor 61, which is independent of the drive for the pairs of cylinders.

In its simplest arrangement, the drive for the counter-pressure cylinder can be taken from the drive for the respective pair of cylinders.

In the preferred arrangement of the present invention, the paired cylinders are driven, as a pair, by a shared common drive motor 61, and the counter-pressure cylinder is driven individually by a separate drive motor 61 of its own.

By use of the printing machine in accordance with the present invention, a printed product, or a web or continuous ribbon can be produced, so that of four webs, after printing, two adjoining webs routed to a former folder intake can each be printed multi-color, and in particular four-color, on one side, and single-color on the other side. The other two webs are printed multi-color, and in particular four-color, on both sides:

For example, a printed product or a continuous ribbon of four webs, taken successively from bottom to top, can have the following color formats: bottom web 1:4, or underside a single color, and upper side four colors, second web from bottom 4:1, third web from bottom 4:4 and fourth web 4:4.

For example, a printed product or a continuous ribbon of four webs, taken successively from bottom to top, can alternatively have the following color formats: bottom web 4:4, or underside four colors, and upper side four colors, second web from bottom 1:4, third web from bottom 4:1 and fourth web 4:4.

For example, a printed product or a continuous ribbon of four webs, taken successively from bottom to top, can have the following color formats: bottom web 4:4 underside four colors, upper side four colors, second web from bottom 1:4, third web from bottom 4:1 and fourth web 4:4.

Furthermore, a printed product can be produced such that, of four adjoining webs after printing on the web to the former folder, three webs are printed multi-color on both side, particularly four-color, and the fourth web is printed single color on both sides.

For example a printed product or a continuous ribbon of four webs, taken successively from bottom to top, can have the following colour formats: bottom web 4:4, or underside four colors, upper side four colors, second web from bottom 1:1, third web from bottom 4:4 and fourth web 4:4.

For example a printed product or a continuous ribbon of four webs, taken successively from bottom to top, can have the following colour formats: bottom web 4:4, or underside four colors, upper side four colors, second web from bottom 4:4, third web from bottom 1:1 and fourth web 4:4.

The arrangement described for the printing machine, and in particular with the six-cylinder printing press 152, permits the variety of production modes described above, without requiring the installation of inflexible print units. The cylinders of the satellite print units 02 and of the six-cylinder printing press 152 can always be driven in the same rotational sense. This provides advantages with respect to the use of minigap technology, i.e. for the narrow opening 28, and with respect to effort required for setting up and for starting.

The printing machine in accordance with the present invention is, for instance, implemented using printing presses that are six page widths wide, in particular in newspaper format. The circumference of at least the forme cylinder 16 corresponds, essentially to the length of two lengths of double printed pages, in particular in newspaper format.

For the cylinders of the three-cylinder printing press 151 the conditions and execution described above, with respect to the cylinder 16; 17 should be used.

While referred embodiments of a printing press, and operating method for the printing press, and resultant printed products, in accordance with the present invention, have been described fully and completely hereinabove, it will be apparent to one of skill in the art that various changes in, for example, the type of web being printed, the specific structure of the folders and formers and the like could be made without departing from the true spirit and scope of the present invention which is accordingly to be limited only by the appended claims.

What is claimed is:

1-79. (canceled)

80. A printing press comprising:
at least one first printing tower;
at least a lower satellite printing unit and an upper satellite printing unit stacked one above the other in said first printing tower, said upper satellite printing unit having upper print locations;
a further printing unit having two printing groups arranged above said stacked lower and upper satellite printing units at a level above said upper print locations of said upper satellite printing unit; and
a plurality of cylinders in each of said lower and upper satellite printing units and said further printing unit, each of said cylinders being adapted to print six side-by-side axially arranged, vertically extending printed pages in newspaper format.

81. The printing press of claim 80 wherein each of said two printing groups is a three-cylinder printing group.

82. The printing press of claim 80 wherein said further printing unit is a six-cylinder printing unit.

83. The printing press of claim 80 wherein at least two webs are printed in said lower and upper satellite printing units on a first side and are printed in said further printing unit in one color on a second side.

84. The printing press of claim 80 wherein said satellite printing units each have offset printing groups.

85. The printing press of claim 81 wherein said three-cylinder printing groups are adapted for offset planographic printing.

86. The printing press of claim 80 wherein said two printing groups are six-cylinder printing units.

87. The printing press of claim 80 wherein said further printing unit is stacked on said at least first printing tower.

88. The printing press of claim 80 further including a second printing tower adjacent said first printing tower and wherein said further printing unit is stacked on one of said first and second printing towers.

89. The printing press of claim 80 wherein said lower and upper satellite printing units are adapted to imprint selectively two webs each multi-colored on one side and one web multi-colored on first and second sides.

90. The printing press of claim 80 wherein each of said satellite printing units is a nine-cylinder satellite printing unit.

91. The printing press of claim 81 wherein in one mode of operation said satellite printing units and said further printing unit are adapted to conduct a web through one of said lower and upper satellite printing units and through one of said three-cylinder printing groups.

92. The printing press of claim 81 wherein said satellite printing units and said further printing unit are adapted for selective operation in a first mode wherein a web is conducted through both of said lower and upper satellite printing units, in a second mode wherein a web is conducted through said one of said satellite printing units and one of said three-cylinder printing groups and in a third mode wherein a web is conducted only through each of said two three-cylinder printing groups.

93. The printing press of claim 80 wherein said satellite printing units and said further printing unit are adapted to conduct a web through one of said satellite printing units and one of said printing groups.

94. The printing press of claim 81 wherein said satellite printing units and said two printing groups are operable selectively in a first mode wherein a first web is conducted through said satellite printing units and a second web is conducted through said two three-cylinder groups, and a second mode wherein each of two webs is conducted selectively through one of said satellite printing units and one of said printing groups.

95. The printing press of claim 80 wherein first and second webs are conducted through said printing tower and said two printing groups for being printed multi-colored on a first web side and single-colored on a second web side.

96. The printing press of claim 80 wherein a first web is conducted through said printing tower and a second web is conducted through said two printing groups wherein said first web is imprinted multi-colored on first and second sides and said second web is imprinted single-colored on first and second sides.

97. The printing press of claim 80 wherein a first web is conducted through said satellite printing units and is imprinted multi-colored on first and second sides and a second web is conducted through said two printing groups and is imprinted in two colors on one side.

98. The printing press of claim 88 wherein said second printing tower has two satellite printing units.

99. The printing press of claim 80 wherein each of said satellite printing units is driven by at least one drive motor independently.

100. The printing press of claim 88 further including a third printing tower adjacent said first and second printing towers, said further printing unit being stacked on one of said first, second and third printing towers.

101. The printing press of claim 100 wherein said further printing unit is stacked on a center one of said adjacent first, second and third printing towers.

102. The printing press of claim 98 wherein first, second and third webs are conducted through said first and second printing towers and said further printing unit whereby said first and second webs are each imprinted multi-colored on a first side and one-colored on a second side and said third web is imprinted multi-colored on first and second sides.

103. The printing press of claim 98 wherein first and second webs are conducted through said first and second printing towers and a third web is conducted only through said further printing unit whereby said first and second webs are imprinted multi-colored on first and second sides and said third web is imprinted single-colored on first and second sides.

104. The printing press of claim 100 wherein four webs are conducted through said first, second and third printing towers and said further printing unit whereby two of said four webs are imprinted multi-colored on a first side and single-colored on a second side and the other two of said four webs are imprinted multi-colored on both first and second sides.

105. The printing press of claim 100 further including means for conducting webs selectively from said first, second and third printing towers to said further printing unit.

106. The printing press of claim 80 wherein said satellite printing units are four color satellite printing units.

107. The printing press of claim 104 further including a former structure after, in a direction of web travel, said printing press and wherein said other two webs are positioned between said two webs while traveling to said former.

108. The printing press of claim 104 wherein said other two webs pass through a center one of said first, second, and third printing towers and said further printing unit.

109. The printing press of claim 104 wherein said other two webs are arranged underneath said two of said four webs after passing through said printing press.

110. The printing press of claim 107 wherein said other two webs pass through one of said first, second and third printing towers located closest to said former.

111. The printing press of claim 107 wherein said other two of said four webs are positioned above said two of said four webs while being directed to said former.

112. The printing press of claim 107 wherein said other two of said four webs pass through one of said first, second and third printing towers located remote from said former.

113. The printing press of claim 107 further including means for directing webs from said first, second and third printing towers and said further printing unit to said former in selected order.

114. The printing press of claim 80 wherein at least one of said lower and upper satellite printing units includes several pairs of cooperating forme and transfer cylinders and at least one satellite cylinder adapted to cooperate with at least one of said transfer cylinders.

115. The printing press of claim 114 wherein there are four of said pairs of cooperating forme and transfer cylinders and one satellite cylinder.

116. The printing press of claim 114 further including a second transfer cylinder and four of said pairs of cooperating forme and transfer cylinders and with said transfer cylinders of two pairs assigned to said one satellite cylinder and with said transfer cylinders of the other two of said four pairs assigned to said second transfer cylinder.

117. The printing press of claim 114 wherein each two of said four pairs of cooperating cylinders are driven for rotation by a compound drive mechanism independently.

118. The printing unit of claim 117 wherein said at least one satellite cylinder is driven by said compound drive mechanism.

119. The printing press of claim 114 wherein said at least one satellite cylinder has an independent drive motor.

120. The printing press of claim 116 wherein said first and second satellite cylinders have a common independent drive motor.

121. The printing press of claim 114 where said of said several pairs of cooperating forme and transfer cylinders has an independent drive motor.

122. The printing press of claim 114 wherein each said forme cylinder and each said transfer cylinder in each said pair has a drive motor.

123. The printing press of claim 114 wherein each of said pairs of cylinders is coupled and is driven by a common drive motor.

124. The printing press of claim 114 further including an inking unit associated with each said forme cylinder and driven by said associated forme cylinder.

125. The printing press of claim 114 further including an inking unit associated with each said forme cylinder and driven independently of each said forme cylinder.

126. The printing press of claim 80 wherein said further printing unit includes at least a first cylinder pair consisting of a forme cylinder and a transfer cylinder and further includes a counter-pressure cylinder acting together with said transfer cylinder.

127. The printing press of claim 126 further including a second cylinder pair consisting of a forme cylinder and a transfer cylinder and further including a counter-pressure cyliner acting together with said transfer cylinder of said second cylinder pair.

128. The printing press of claim 127 wherein each said second cylinder pair has an independent second cylinder pair drive motor.

129. The printing press of claim 127 wherein said cylinder in said second cylinder pair has its own drive motor.

130. The printing press of claim 127 wherein each said second cylinder pair has a common drive motor.

131. The printing press of claim 127 further including one inking unit driven from a location of said forme cylinder of said second cylinder pair.

132. The printing pair of claim 127 further including an inking unit cooperating with each said first and second cylinder pair forme cylinders, each said inking unit being its own independent drive motor.

133. The printing press of claim 127 further including an independnet counter-pressure cylinder drive motor for each said counter-pressure cyliner.

134. The printing press of claim 127 wherein said two counter-pressure cylinders are driven by at least one common drive motor independently of said first and second cylinder pairs.

135. The printing press of claim 127 wherein said second counter-pressure cylinder is driven from a location of said associated one of said first and and second cylinder pairs.

136. The printing press of claim 128 further including a counter-pressure drive motor for each said counter-pressure cylinder.

137. A printed product printed in a printing press having three printing towers and a former including an inlet and including four webs situated adjacent said other, a first two of said four webs located adjoining each other being printed multi-colored on a first side and in a single color on a second side, the other two of said four webs each being imprinted in multi-colors on first and second sides.

138. The printed product of claim 137 wherein said first two of said four webs are located beneath said second two of said four webs.

139. The printed product of claim 137 wherein said first two of said four webs are between said second two of said four webs.

140. A printed product of a printing press having four webs which adjoin each other and which have been printed in three printing towers and which are directed to a former inlet, a first three of said four webs each being printed on first and second sides in multiple colors, said fourth one of said four webs being printed on first and second sides in one color.

141. The printed product of claim 140 wherein said fourth one of said four webs is second from the bottom.

142. The printed product of claim 140 wherein said fourth one of said four webs is second from the top.

143. The printing press of claim 80 wherein each of said printing units includes a forme cylinder having a circumferential length corresponding to the length of two printed pages in newspaper format.

144. The printing press of claim 80 wherein each of said printing units includes a forme cylinder having six plates assigned side-by-side in said axial direction of each said forme cylinder.

145. The printing press of claim 80 further including a folding apparatus having a transport cylinder, said transport cylinder having a circumferential surface with a length sufficient to receive at least seven lengths of said printed paper arranged one behind another in a circumferential direction of said transfer cylinder

146. The printing press of claim 80 further including a folding apparatus including cylinders driven by at least one independent drive motor.

147. The printing press of claim 146 wherein folding apparatus includes a transport cylinder having a circumferential surface with a length sufficient to receive at least seven lengths of said printed pages arranged one behind another in a circumferential direction of said transfer cylinder.

148. The printing press of claim 145 further including three formers arranged side-by-side and adapted to drive three continuous webs to said transport cylinder.

149. The printing press of claim 145 further including seven circumferentially spaced retaining devices on said transfer cylinder.

150. The printing press of claim 145 further including first and second individually driven traction roller pairs at an inlet to said folding apparatus.

151. The printing press of claim 145 wherein said folding apparatus includes first and second cutting cylinders adapted to operate with said transport cylinder.

152. The printing press of claim 145 wherein each of said satellite printing units, said further printing unit and said folding apparatus are rotationally driven, independently of each other, by drive motors.

153. The printing press of claim 80 wherein each of said satellite printing units and said further printing unit each have at least one forme cylinder having printing plate end receiving, axially extending slits arranged side-by-side in an axial direction of each said forme cylinder.

154. The printing press of claim 153 wherein said plurality of plate end receiving slits are aligned and form a continuous, axially extending slit.

155. The printing press of claim 153 wherein said slits are alternatingly arranged offset by 180° from each other.

156. The printing press of claim 80 wherein each of said satellite printing units and said further printing unit includes a transfer cylinder having blanket end receiving, axially extending slits arranged side-by-side on said transfer cylinder.

157. The printing press of claim 80 wherein each of said satellite printing units and said further printing unit includes a transfer cylinder having transfer cylinder dressings on their surfaces, said transfer cylinder dressings each including a support plate adjacent said transfer cylinder surface and a compressible layer on said support plate.

158. The printing plate of claim 80 wherein said two printing groups each include a forme cylinder and a transfer cylinder driven by their own drive motors.
